(19) United States
(12) Patent Application Publication
(10) Pub. No.: US 2025/0181829 A1
(43) Pub. Date: Jun. 5, 2025

(54) GRAMMATICAL ERROR DETECTION UTILIZING LARGE LANGUAGE MODELS

(71) Applicant: GOOGLE LLC, Mountain View, CA (US)

(72) Inventor: Dongeek Shin, San Jose, CA (US)

(21) Appl. No.: 18/528,091

(22) Filed: Dec. 4, 2023

(51) Int. Cl. G06F 40/253; G06F 16/332; G06F 40/40

(52) U.S. Cl. CPC G06F 40/253; G06F 16/3329; G06F 40/40

(57) ABSTRACT

Implementations described herein relate to utilizing a large language model (LLM) to determine whether a natural language (NL) based input is grammatically incorrect and notifying a user based on the determination. A structured LLM query may be generated, based on the NL based input, that includes an LLM prompt to cause the LLM to generate an LLM response including an indication of whether the NL based input is grammatically incorrect. An LLM response may be generated, based on causing the structured LLM query to be processed using the LLM, that includes the indication of whether the NL based input is grammatically incorrect. Responsive to determining that the NL based input is grammatically incorrect based on the LLM response, a feedback output may be caused to be rendered at the client device, or an additional client device, that indicates the NL based input is grammatically incorrect.

### BACKGROUND

Large language models (LLMs) are particular types of generative machine learning models that can perform various natural language processing (NLP) tasks, such as language generation, machine translation, and question-answering. These LLMs are typically trained on enormous amounts of diverse data including data from, but not limited to, webpages, electronic books, software code, electronic news articles, and machine translation data. Accordingly, these LLMs leverage the underlying data on which they were trained in performing these various NLP tasks. For instance, in performing a language generation task, these LLMs can process a natural language (NL) based input that is received from a client device, and generate an NL based output that is responsive to the NL based input and that is to be rendered at the client device. However, current utilizations of LLMs suffer from one or more drawbacks.

In some cases, a user may provide an LLM with an NL based input that contains one or more grammatical errors. While the LLM may still generate an NL based output that is responsive to the grammatically incorrect NL based input, however the presence of one or more grammatical errors in the NL based input may result in the NL based output being flawed and/or not as desired by the user.

The user may be unaware that the NL based input they provided was grammatically incorrect. As such, in some instances the user may be dissatisfied with the NL based output provided by the LLM yet be unaware that one or more grammatical errors in the NL based input were the cause of the undesirable output. The user may therefore provide one or more additional NL based inputs to the LLM in an effort to cause a desired action(s) to be performed and/or desired responsive content to be provided by the LLM, thereby increasing a quantity of user input(s) and wasting computational resources, whereby the consumption of computational resources by LLMs, that can already be substantial, are increased. In other instances, the user may simply accept the sub-optimal NL based output provided by the LLM on the incorrect assumption that the NL based output is responsive to their intended (i.e., grammatically correct) NL based input, rather than the grammatically incorrect NL based input the user actually provided to the LLM.

### SUMMARY

Implementations described herein relate to the determination and surfacing to a user of whether a natural language (NL) based input provided by a user to a client device is grammatically incorrect. Processor(s) can generate a structured large language model (LLM) query based on the NL based input that can be processed to generate LLM response. The LLM response can include content responsive to the NL based input and an indication of whether the NL based input contains a grammatical error. The processor(s) can parse the LLM response to identify the indication of whether the NL based input contains a grammatical error and, responsive to the indication indicating that the NL based input contains a grammatical error, causing a feedback output indicative of the grammatical error to be rendered, for example at the client device. Accordingly, a user can be notified that their NL based input contained a grammatical error.

Implementations described herein can serve to notify a user that an NL based input they provided to a client device was grammatically incorrect, where the user may otherwise not have been aware. As such, the user may be encouraged to provide a follow-up NL based input in which they attempt to correct any grammatical errors. In some examples, the feedback output includes an indication of a particular grammatical error in the NL based input and/or a grammatically correct version of the NL based input, thereby guiding the user to provide a follow-up NL based input that is grammatically correct.

In some implementations, a method implemented by one or more processors is provided that includes receiving natural language based input associated with a client device; generating, based on the NL based input, a structured large language model (LLM) query, wherein the structured LLM query comprises an LLM prompt to cause an LLM to generate an LLM response that includes an indication of whether the NL based input is grammatically incorrect; generating the LLM response based on causing the structured LLM query to be processed using the LLM, the LLM response including the indication of whether the NL based input is grammatically incorrect; determining, based on processing the indication included in the LLM response, whether the NL based input is grammatically incorrect; and responsive to determining that the NL based input is grammatically incorrect, causing a feedback output to be rendered at the client device or an additional client device, the feedback output to indicate to a user that the NL based input is grammatically incorrect.

In some implementations, the LLM prompt is a predetermined prompt that has been stored prior to receiving the NL based input. Leveraging use of an LLM and a predetermined LLM prompt may provide a simple means of determining whether an NL based input is grammatically incorrect.

In some implementations, the processors(s) can determine whether to generate the structured LLM query. In such implementations, generating the structured LLM query may be performed in response to determining to generate the structured LLM query. As such, the detection of grammatical errors may be performed under only certain circumstances. In some versions of those implementations, determining whether to generate the structured LLM query may be based on receiving an indication of a user input to initiate incorrect grammar detection. For example, a user may provide an implicit or explicit input indicative of the user desiring an NL based input to be processed to detect incorrect grammar. As an example, a provided by the user for NL based input to be transcribed may be indicative of the user desiring incorrect grammar detection to be performed on the NL based input.

In some implementations, an indication of whether the NL based input is grammatically incorrect may comprise at least one of an indication of whether a word in the NL based input is grammatically incorrect, and an indication of whether a sentence in the NL based input is grammatically incorrect.

In some implementations, the LLM prompt may further cause the LLM to output, in the LLM response, a grammatically correct version of the NL based input. The processors(s) may further cause at least a portion of the grammatically correct version of the NL based input to be rendered by the client device or the additional client device. As such, a user may be guided to provide a grammatically correct version of the NL based input as a subsequent NL based input.

In some implementations, subsequent to the processors(s) causing the feedback output to be rendered, an additional NL based input may be received from a user. This additional NL based input may be a follow-up NL based input provided by the user in an attempt to correct one or more grammatical errors in the previous NL based input. The processors(s) may determine whether the additional NL based input is grammatically incorrect and, responsive to determining that the additional NL based input is grammatically incorrect, cause an additional feedback output to be rendered at the client device or the additional client device, the additional feedback output to indicate to the user that the additional NL based input is grammatically incorrect. In some versions of those implementations, the first feedback output and the additional feedback output may be different (e.g., output using different modalities). For example, the first feedback output may comprise a visual output and the additional feedback output may comprise an audible output. As such, a more salient feedback output may be provided when the user fails to correct a previous grammatically incorrect NL based input.

In some implementations, the LLM prompt may cause the LLM to output, in the LLM response, a grammatically correct version of the NL based input. In such implementations, the additional feedback output may comprise at least a portion of the grammatically correct version of the NL based input.

In additional or alternative versions of those implementations, determining whether the additional NL based input is grammatically incorrect comprises: generating, based on the additional NL based input, an additional structured LLM query; generating an additional LLM response based on causing the additional structured LLM query to be processed using the LLM or a different LLM, wherein the additional LLM response includes an indication of whether the additional NL based input is grammatically incorrect; and determining, based on processing the additional LLM response, whether the additional NL based input is grammatically incorrect.

In additional or alternative versions of those implementations, determining whether the additional NL based input is grammatically incorrect comprises performing a comparison between at least a portion of the additional NL based input and at least a portion of the grammatically correct version of the NL based input; and the additional NL based input is determined to be grammatically incorrect based on a result of the comparison.

In some implementations, causing the feedback output to be rendered comprises: causing at least a portion of the NL based input to be rendered as an audible or visible NL based output; and causing an audible or visible indication of at least one grammatical error in the NL based output to be rendered.

In some implementations, the method further comprises: subsequent to causing the feedback output to be rendered, receiving an additional NL based input; generating, based on the additional NL based input, an additional structured LLM query; generating, based on causing the additional structured LLM query to be processed using the LLM or a different LLM, an additional LLM response, wherein the additional LLM response includes an indication of whether the additional NL based input is grammatically incorrect; and causing an additional feedback output to be rendered at the client device or the additional client device, the additional feedback output to indicate to the user that the additional NL based input is grammatically incorrect.

In some versions of those implementations, the feedback output indicates a grammatical error in the NL based input with a first level of granularity, the additional feedback output indicates a grammatical error in the further NL based input with a second level of granularity, and the second level of granularity is greater than the first level of granularity.

In some versions of those implementations, the first level of granularity corresponds to a sentence-level of granularity and the second level of granularity corresponds to a word-level of granularity.

In some implementations, the NL based input comprises a query for information; the LLM response comprises content responsive to the query for information; and the feedback output is caused to be rendered in lieu of rendering the content responsive to the query for information.

In some implementations, the indication in the LLM response is indicative of at least one of: a relative importance of a grammatical error identified in the NL based input; a location of a grammatical error identified in the NL based input; or a type of grammatical error identified in the NL based input.

In some implementations, the indication in the LLM response comprises an error value, the error value being indicative of a relative importance of at least one grammatical error contained in the NL based input, wherein causing the feedback output to be rendered is based on a magnitude of the error value.

In some implementations, the feedback output is caused to be rendered at substantially a same instance in time as the NL based input is received.

In some implementations, the feedback output comprises at least one of an audible output, a visual output or a haptic output.

In some implementations, causing the feedback output to be rendered at the client device or an additional client device comprises transmitting data to the client device or the additional device that is operable for causing the client device or additional device to render the feedback output.

In some implementations, a further method implemented by one or more processors is provided, the method comprising: receiving natural language (NL) based input associated with a client device; determining whether to generate a structured large language model (LLM) query, the structured LLM query comprising a prompt to cause an LLM to generate an LLM response that includes an indication of whether the NL based input is grammatically incorrect; in response to determining to generate the structured LLM query: generating the structured large language model (LLM) query based on the NL based input, wherein the structured LLM query comprises a prompt to cause the LLM to generate the LLM response that includes the indication of whether the NL based input is grammatically incorrect; and generating the LLM response based on processing the structured LLM query using the LLM, wherein the LLM response includes the indication of whether the NL based input is grammatically incorrect; determining, based on processing the LLM response, whether the NL based input is grammatically incorrect; and responsive to determining that the NL based input is grammatically incorrect, causing a feedback output to be rendered at the client device or an additional client device, the feedback output to indicate to a user that the NL based input is grammatically incorrect.

In some versions of those implementations, determining whether to generate a structured large language model (LLM) query may be based on receiving an indication of a user input to initiate incorrect grammar detection.

In additional or alternative versions of those implementations, the method may further comprise: subsequent to causing the feedback output to be rendered, receiving an additional NL based input; determining whether to generate an additional structured LLM query for the additional NL based input, the additional structured LLM query comprising a prompt to cause an LLM to generate an LLM response that includes an indication of whether the additional NL based input is grammatically incorrect; and in response to determining not to generate the additional structured LLM query: causing the additional NL based input to be processed by at least one machine learning (ML) model to generate ML output responsive to the additional LLM query, in lieu of generating the additional structured LLM query.

In some implementations, causing the feedback output to be rendered at the client device or an additional client device may comprise transmitting data to the client device or the additional device that is operable for causing the client device or additional device to render the feedback output.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

The above description is provided as an overview of only some implementations disclosed herein. Those implementations, and other implementations, are described in additional detail herein. Further, it should be understood that techniques disclosed herein can be implemented locally on a client device, remotely by server(s) connected to the client device via one or more networks, and/or both.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts an example process flow for determining whether an NL based input is grammatically incorrect that demonstrates various aspects of FIG. 1, in accordance with various implementations.

FIG. 3 depicts a flowchart illustrating an example method of determining whether an NL based input is grammatically incorrect and causing a feedback output to be rendered, in accordance with various implementations.

FIG. 4A and FIG. 4B depict a flowchart illustrating another example method of determining whether an NL based input is grammatically incorrect and causing a feedback output to be rendered, in accordance with various implementations.

FIG. 5A and FIG. 5B depict a flowchart illustrating another example method of determining whether an NL based input is grammatically incorrect and causing a feedback output to be rendered, in accordance with various implementations.

FIG. 6A depicts a non-limiting example of determining whether an NL based input received via a client device is grammatically incorrect and causing a feedback output to be rendered at the client device, in accordance with various implementations.

FIG. 6B depicts another non-limiting example of determining whether an NL based input received via a client device is grammatically incorrect and causing a feedback output to be rendered at the client device, in accordance with various implementations.

FIG. 7 depicts another non-limiting example of determining whether an NL based input received via a client device is grammatically incorrect and causing a feedback output to be rendered at the client device, in accordance with various implementations.

FIG. 8 depicts another non-limiting example of determining whether an NL based input received via a client device is grammatically incorrect and causing a feedback output to be rendered at the client device, in accordance with various implementations.

FIG. 9 depicts an example architecture of a computing device, in accordance with various implementations.

### DETAILED DESCRIPTION OF THE DRAWINGS

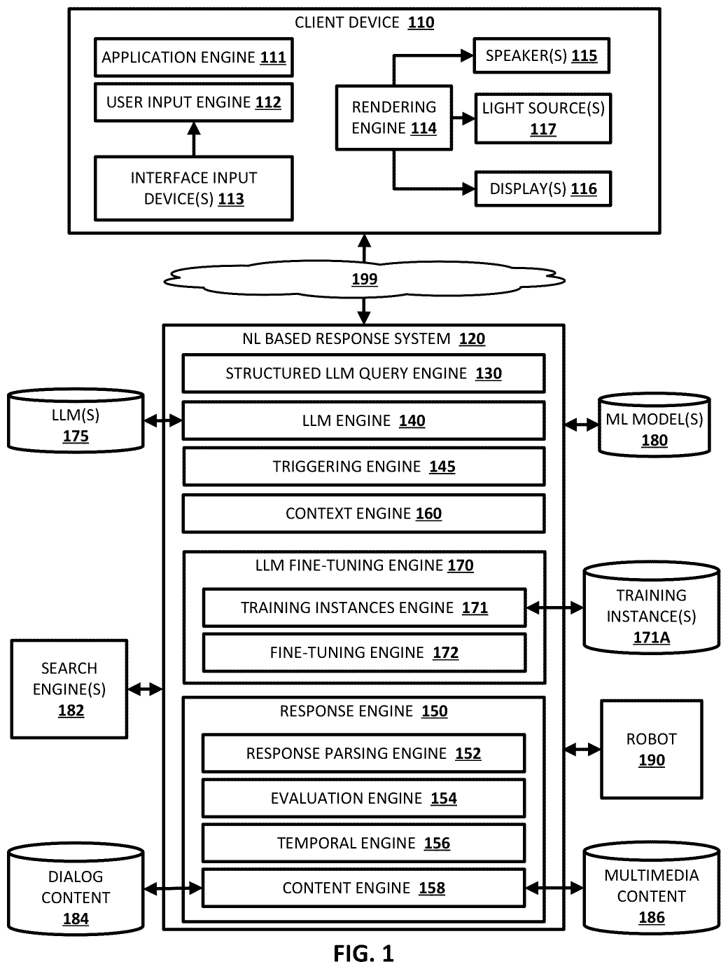

Turning now to FIG. 1, a block diagram of an example environment that demonstrates various aspects of the present disclosure and in which implementations disclosed herein can be implemented is depicted. The example environment includes a client device 110 and a natural language (NL) based response system 120.

In some implementations, all or some aspects of the NL based response system 120 can be implemented locally at the client device 110. In additional or alternative implementations, all or some aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs”, including Wi-Fi, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 111, through which NL based input can be submitted and/or NL based output and/or other output that is responsive to the NL based input can be rendered (e.g., audibly and/or visually). The application engine 111 can execute one or more software applications that are separate from an operating system of the client device 110 (e.g., one installed “on top” of the operating system)—or can alternatively be implemented directly by the operating system of the client device 110. For example, the application engine 111 can execute a web browser or automated assistant installed on top of the operating system of the client device 110. As another example, the application engine 111 can execute a web browser software application or automated assistant software application that is integrated as part of the operating system of the client device 110. The application engine 111 (and the one or more software applications executed by the application engine 111) can interact with the NL based response system 120.

In various implementations, the client device 110 can include a user input engine 112 that is configured to detect user input provided by a user of the client device 110 using one or more user interface input devices 113 of the client device 110 (or a device in communication with the client device 110). For example, the user interface input device(s) 113 can comprise one or more microphones that capture audio data, such as audio data corresponding to spoken utterances of the user or other sounds in an environment of the client device 110. Additionally, or alternatively, the user interface input device(s) 113 can comprise one or more touch sensitive components (e.g., a keyboard, a mouse, a stylus, a touch screen, a touch panel, one or more hardware buttons, etc.) that are configured to capture signal(s) corresponding to touch or typed input directed to the client device 110. Additionally, or alternatively, the user interface input device(s) 113 can comprise one or more vision components that are configured to capture vision data corresponding to images and/or movements (e.g., gestures) detected in a field of view of one or more of the vision components.

Some instances of an NL based input described herein can be a query for an NL response that is formulated based on user input provided by a user of the client device 110 via user interface input device(s) 113 and detected using the user input engine 112. For example, the query can be a spoken voice query that is detected via microphone(s) of the client device 110 (and optionally directed to an automated assistant executing at least in part at the client device 110), a typed query that is typed via a physical or virtual keyboard, or an image or video query that is based on vision data captured by vision component(s) of the client device 110 (or based on NL input generated based on processing the image using, for example, object detection model(s), captioning model(s), optical character recognition etc.).

In some examples, the user input engine 112 can cause audio data that captures a spoken utterance of a user and that is generated by microphone(s) of the client device 110 to be processed using automatic speech recognition (ASR) model(s) (e.g., a recurrent neural network (RNN) model, a transformer model, and/or any other ML model capable of performing ASR) to generate the NL based input as an NL ASR output.

In various implementations, the client device 110 can include a rendering engine 114 that is configured to render content (e.g., NL based response(s)) or other outputs for audible and/or visual presentation to a user of the client device 110 using one or more user interface output devices of the client device 110 (or in communication with the client device 110). For example, the client device 110 can be equipped with one or more speakers 115 that enable the content to be provided for audible presentation to the user via the client device 110. In implementations where textual content is to be audibly rendered (e.g., responsive to the NL based input), the rendering engine 114 can cause the textual content to be processed using one or more text-to-speech model(s) to generate synthesized speech audio data that includes computer-generated synthesized speech capturing the content. The synthesized speech audio data can be audibly rendered for presentation to the user via the speaker(s) 115 of the computing device 110. In implementations where visual content is to be visually rendered (e.g., responsive to the NL based input), the rendering engine 114 can cause the visual content to be to be visually rendered for presentation to the user, for example using a display 116 or projector of the client device 110. Additionally, or alternatively, the client device 110 can be equipped with a light emitting diode (LED) or another type of light source(s) 117 that can be controlled by the rendering engine 114 to render a visual output (e.g., by switching the light source(s) 117 on or off).

Although FIG. 1 depicts the user input engine 112 as forming part of the client device 110, it should be noted that in other examples, the user input engine 112, or a portion thereof, may be located in the NL based response system 120, or in a different device or system to the client device 110 and NL based response system 120. Furthermore, although FIG. 1 depicts the rendering engine 114 as forming part of the client device 110, it should be noted that in other examples, the rendering engine 114, or a portion thereof, may be located in the NL based response system 120, or in a different device or system to the client device 110 and NL based response system 120.

The client device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

The NL based response system 120 is illustrated in FIG. 1 as including a structured LLM query engine 130, an LLM engine 140, a triggering engine 145, a context engine 160, an LLM fine-tuning engine 170 and a response engine 150. Some of these engines can be combined and/or omitted in various implementations. Further, these engines can include various sub-engines. For instance, the response engine 150 is illustrated in FIG. 1 as including a response parsing engine 152, an evaluation engine 154, a temporal engine 156, and a content engine 158, while the LLM fine-tuning engine 170 is illustrated in FIG. 1 as including a training instances engine 171 and a fine-tuning engine 172. Similarly, some of these sub-engines can be combined and/or omitted in various implementations. Accordingly, it should be understood that the various engines and sub-engines of the NL based response system 120 illustrated in FIG. 1 are depicted for the sake of describing certain functionalities and is not meant to be limiting.

Further, the NL based response system 120 is illustrated in FIG. 1 as interfacing with various databases, such as LLM(s) database 175, machine learning (ML) model(s) database 180, training instance(s) database 171A, dialog content database 184, and multimedia content database 186. Although particular systems, engines and/or sub-engines are depicted as having access to particular databases, it should be understood that is for the sake of example and is not meant to be limiting. For instance, in some implementations, each of the various engines and/or sub-engines of the NL based response system 120 can have access to each of the various databases. Further, some of these databases can be combined and/or omitted in various implementations. Further, some of these databases can be wholly or partly comprised in the client device 110 and/or the NL based response system 120. Accordingly, it should be understood that the various databases interfacing with the NL based response system 120 illustrated in FIG. 1 are depicted for the sake of describing certain data that is accessible to the NL based response system 120 and is not meant to be limiting.

The NL based response system 120 is further illustrated in FIG. 1 as interfacing with one or more search engines 182 and a robot 190. In some implementations, the NL based response system 120 may interface with the one or more search engines 182 and/or the robot 190 over one or more of the networks 199. In some implementations, the one or more search engines 182 and/or robot 190 may form part of the NL based response system 120 or the client device 110. It should be understood that in some implementations the NL based response system 120 does not interface with one or more search engines 182 and/or does not interface with a robot 190.

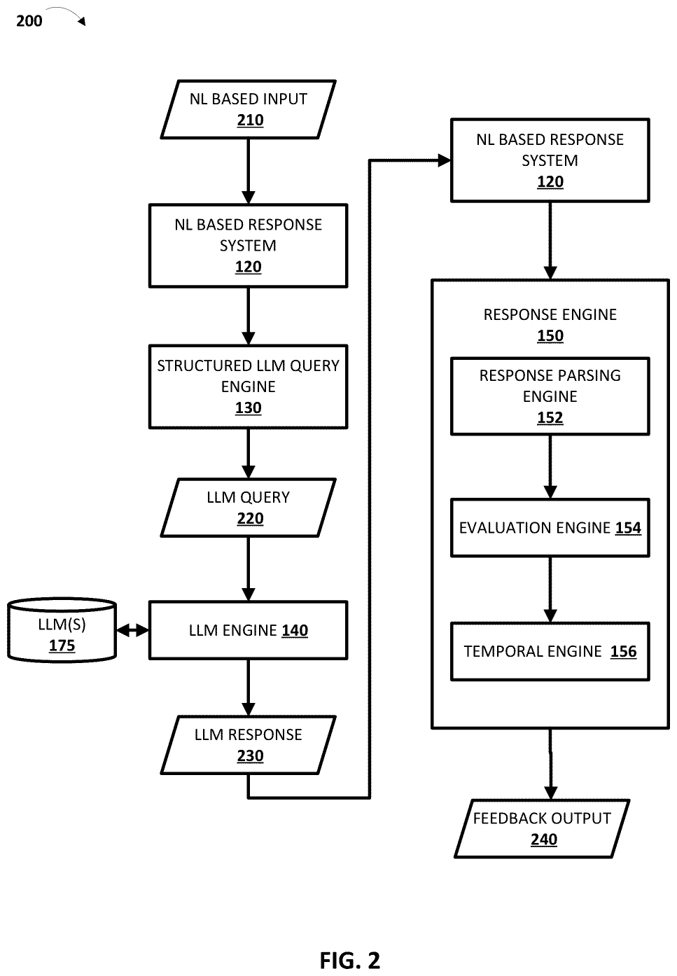

As described in more detail herein (e.g., with respect to FIGS. 2, 3, 4A, 4B, 5A, 5B, 6A, 6B, 7 and 8), the NL based response system 120 can be utilized to determine whether an NL based input received from a user is grammatically incorrect, that is whether the NL based input contains one or more grammatical errors. Examples of grammatical errors include the use of an incorrect tense, the use of an incorrect word such as an incorrect verb, noun, adjective or adverb, the incorrect use of singular or plural word forms, the presence of an unclear pronoun reference, and the incorrect use or omission of an article (e.g., “a”, “an” or “the”). The aforementioned examples of grammatical errors are provided merely by way of example and it should be understood that other types of grammatical error may be additionally and/or alternatively identified. The presence of at least one grammatical error in the NL based input will be indicative of the NL based input being grammatically incorrect. The NL based response system 120 can be utilized to cause a feedback output to be rendered in response to a determination that an NL based input is grammatically incorrect, to indicate to the user providing the NL based input that the received NL based input is grammatically incorrect. The feedback output may be caused to be rendered at a client device 110 associated with the NL based input and/or another client device that interfaces with the NL based response system 120.

The structured LLM query engine 130 is configured to process an NL based input received at the NL based response system 120 to generate a structured LLM query. The structured LLM query engine 130 can generate the structured LLM query (hereafter “LLM query”) by transforming the NL based input into a structured format that can be processed by an LLM (e.g., an LLM stored in the LLM(s) database 175). The LLM query comprises an LLM prompt which, when processed by an LLM (e.g., stored in the LLM(s) database 175), causes the LLM to generate as an output an LLM response that includes an indication of whether the NL based input is grammatically incorrect (i.e. an indication of whether or not the NL based input contains one or more grammatical errors).

The triggering engine 145 can determine whether a structured LLM query should be generated by the structured LLM query engine 130. In some implementations, the triggering engine 145 can determine to generate the structured LLM query based on a software application of the client device 110 being launched and/or user input directed to the software application being received. In some versions of those implementations, the software application can be a first-party software application, whereas in other versions of those implementations, the software application can be a third-party application. As used herein, the term “first-party” is associated with a first-party entity that manages and/or hosts the NL based response system 120, whereas the term “third-party” is associated with a third-party entity that is a distinct entity from the first-party entity that manages and/or hosts the NL based response system 120. Accordingly, in versions of those implementations where the software application is a third-party software application, the first-party entity can provide the NL based response system 120 as a service to the third-party.

In some implementations, the triggering engine 145 determines that a structured LLM query should be generated in response to receiving an indication of a user input to initiate incorrect grammar detection by the NL based response system 120. Such a user input could be provided by a user via one or more interface input devices 113 of the client device 110.

In additional or alternative implementations, the triggering engine 145 can determine to generate the structured LLM query based on receiving a signal indicative of the user performing dictation for the client device 110 and/or NL based response system 120 (i.e. that the user has requested that the client device 110 and/or NL based response system 120 transcribe one or more utterances to be provided (or having been provided) as an audio input to the client device 110).

The LLM engine 140 can cause the LLM (e.g., stored in the LLM(s) database 175) to process the LLM query generated by the structured LLM query engine 130, to thereby generate an LLM response that is responsive to the LLM query, the LLM response including an indication of whether the NL based input is grammatically incorrect. Causing the LLM to process the LLM query may comprise transmitting data to the LLM, the data being operable to cause the LLM to process the LLM query.

The LLM can include, for example, any LLM that is stored in the LLM(s) database 175, such as PaLM, BARD, BERT, LaMDA, Meena, GPT, and/or any other LLM, such as any other LLM that is encoder-only based, decoder-only based, sequence-to-sequence based and that optionally includes an attention mechanism or other memory.

Prior to the structured LLM query being processed, the LLM fine-tuning engine 170 can fine-tune the LLM (e.g., stored in the LLM(s) database 175) based on a plurality of training instances. By fine-tuning the LLM based on the plurality of training instances, the LLM is effectively trained to generate the LLM response that includes the indication of whether the NL based input is grammatically incorrect.

For example, the LLM fine-tuning engine 172 can identify an LLM (e.g., stored in the LLM(s) database 175) that is to be fine-tuned. Notably, the LLM can include millions or billions of weights and/or parameters that are learned through training the LLM on enormous amounts of diverse data. This enables the LLM (e.g., prior to fine-tuning) to generate the LLM response as the probability distribution over a sequence of tokens and based on processing the structured LLM query including the NL based input, the LLM prompt, and/or other data. However, due to the “real-time” nature of the feedback output described herein, it should be understood that a balance of model size and computational efficiency is a consideration in determining the LLM to be fine-tuned and/or subsequently utilized to perform techniques described herein.

Further, the training instances engine 171 can obtain (e.g., from training instance(s) database 171A) and/or generate a plurality of training instances. Each of the training instances can include a corresponding structured LLM query, and a corresponding LLM response that is associated with the corresponding structured LLM query. For instance, a given training instance, of the plurality of training instances, can include a grammatically incorrect NL based input and a corresponding LLM response that includes an indication that the NL based input is grammatically incorrect. Optionally, the given training instance may also include, in the LLM response, a grammatically correct version of the NL based input. As another example, a given training instance, of the plurality of training instances, can include a grammatically correct NL based input and a corresponding LLM response that includes an indication that the NL based input is grammatically correct.

The fine-tuning engine 172 can cause the identified LLM to be fine-tuned based on the plurality of training instances to generate a fine-tuned LLM, and can cause the fine-tuned LLM to be stored in the LLM(s) database 175. By generating the fine-tuned LLM based on the plurality of training instances, the fine-tuned LLM is able to process an LLM query comprising an NL based input to generate an LLM response output that includes the indication of whether the NL based input is grammatically incorrect, and optionally also output a grammatically correct version of a grammatically incorrect NL based input in the LLM response.

The response engine 150 is configured to determine, based on processing the indication included in the LLM response, whether the NL based input is grammatically incorrect. As an example, the response engine 150 may include a response parsing engine 152 arranged to parse the LLM response output by an LLM to identify the indication included in the LLM response and an evaluation engine 154 to determine, based on the indication identified by the response parsing engine 152, whether the NL based input is grammatically incorrect.

Responsive to the response engine 150 determining that the NL based input is grammatically incorrect, the response engine 150 may cause a feedback output to be rendered at the client device 110 or at an additional client device (i.e. a different client device to the client device 110 from which the NL based input was originally received), for example using the rendering engine 114 of the client device 110 (or the additional client device). The feedback output indicates to a user that the NL based input is grammatically incorrect. The feedback output could comprise a visual output, for example rendered using light source(s) 117 such as an LED of the client device 110 (or additional client device) or using an electronic display 116 of the client device 110 (or additional client device(s) of the user of the client device 110).

Additionally, or alternatively, the feedback output could comprise an audio output, for example rendered using one or more speakers 115 of the client device 110 or additional client device(s) of the user of the client device 110. Additionally, or alternatively, the feedback output could comprise a haptic output, for example rendered using a vibration generator of the client device 110 or additional client device(s) of the user of the client device 110. These types of feedback output are provided as examples, and it is envisaged that other types of feedback output could be used to indicate to a user that the NL based input received at the client device 110 is grammatically incorrect.

In some implementations, the response engine 150 may comprise a temporal engine 156 for determining an instance in time in which to cause the feedback output to be rendered. For example, the temporal engine 156 in some instances may determine that the response engine 150 should cause the feedback output to be rendered immediately (i.e., as soon as the evaluation engine 154 has determined that the indication in the LLM response is indicative of the NL based input being grammatically incorrect and that a feedback output should be caused to be rendered). As such, the feedback output may be caused to be rendered at substantially a same instance in time as the NL based input is received (i.e. in ‘real-time’). Causing the feedback output to be rendered at substantially a same instance in time as the NL based input is received may comprise causing the feedback output to be rendered at substantially the same time as a grammatically incorrect portion of the NL based input is received, or within a threshold duration of time (e.g., 5 milliseconds, 10 milliseconds, etc.) of a grammatically incorrect portion of the NL based input being received. In other instances, the temporal engine 156 may determine that the response engine 150 should cause the feedback output to be rendered at a later instance in time, for example a fixed period of time after the evaluation engine 154 has determined that a feedback output should be rendered, or in response to an additional input being received (such as an input indicating that a user has stopped providing an NL input to the client device 110). Based on determining when to render the feedback output, the temporal engine 156 can generate temporal data, and provide the temporal data to the rendering engine 114 for utilization in causing the feedback output to be rendered at the client device 110 at a time indicated by the temporal data.

In some examples, the response engine 150 includes a content engine 158 which may be used to obtain content that is responsive to the NL based input. The content engine 158 may be coupled to one or more databases such as a dialog content database 184 and/or a multimedia content database 186. The content engine 158 may obtain content from the database(s) based on the LLM response generated using the LLM, for providing to the client device 110 (or additional client device) for rendering. For example, the content engine 158 may request dialog content (e.g., a snippet of text) from the dialog content database 184 and/or multimedia content (e.g. a song, an image, a video, etc.) from the multimedia content database 186.

The content engine 158 may request and obtain content from the database(s) in response to a request (explicit or implied) for such content being contained within the LLM response generated using the LLM. For example, based on an NL based input of “What is the capital of England?”, the LLM may generate an LLM response comprising an indication of whether the NL based input is grammatically incorrect. In addition, the LLM response may comprise NL content of “The capital of England is London” that is responsive to the NL based input. The content engine 158 may identify the NL content contained within the LLM response (in some examples after the LLM response has been parsed using the response parsing engine 152 to identify the NL content) and obtain additional content from the dialog content database 184 and/or multimedia content database 186 that corresponds to the NL content. For example, in response to the NL content of “The capital of England is London”, the content engine 158 may request an image from the multimedia content database 186 that corresponds to “London”, receive such an image from the multimedia content database 186, and cause the image to be rendered, for example at display(s) 116 of the client device 110 using the rendering engine 114. The aforementioned is given merely by way of an example and it can be envisaged that other types of content may alternatively or additionally be requested by the content engine 158, such as dialog content and/or video content. Furthermore, content requested and obtained by the content engine 158 may be caused to be rendered at the client device 110 or at a different client device in communication with the NL based response system 120.

In various implementations, the client device 110 can include a context engine 160 that is configured to determine a context (e.g., current or recent context) of the client device 110 and/or of a user of the client device 110 (e.g., an active user of the client device 110 when the client device 110 is associated with multiple users). In some of those implementations, the context engine 160 can determine a context based on data stored in the client device 110, the NL based response system 120 or a different system, wherein the data can include, for example, user interaction data that characterizes current or recent interaction(s) of the client device 110 and/or a user of the client device 110, location data that characterizes a current or recent location(s) of the client device 110 and/or a user of the client device 110, user attribute data that characterizes one or more attributes of a user of the client device 110, user preference data that characterizes one or more preferences of a user of the client device 110, user profile data that characterizes a profile of a user of the client device 110, and/or any other data accessible to the context engine 160.

For example, the context engine 160 can determine a current context based on a current state of a dialog session between a user and an assistant (e.g., considering one or more recent inputs provided by a user during the dialog session), profile data, and/or a current location of the client device 110. For instance, the context engine 160 can determine a current context of “best landmarks to visit in London” based on a recently issued query, profile data, and/or a current or an anticipated future location of the client device 110 (e.g., based on calendar information associated with the user accessible to the context engine 160). As another example, the context engine 160 can determine a current context based on which software application is active in the foreground of the client device 110, a current or recent state of the active software application, and/or content currently or recently rendered by the active software application. A context determined by the context engine 160 can be utilized, for example, in determining whether to generate a structured LLM query based on the NL based input. Additionally, or alternatively, a context determined by the context engine 160 can be utilized in generating a structured LLM query.

In various implementations, the NL based response system 120 may be in communication with one or more search engines 182 and/or one or more machine learning (ML) model databases 180 that store one or more other ML models (i.e. ML models that are different to the LLM model stored in the LLM database(s) 175). One or more of the search engines 182 and/or one or more of the ML models stored in the machine learning model databases 180 may be utilized by the NL based response system 120 to generate content that is responsive to the NL based input. The NL based response system 120 may submit a request for content responsive to the NL based input to one or more of the search engines 182 and/or one or more of the ML models stored in the ML model database(s) 180. The one or more search engines 182 and/or one or more ML models is caused to generate content responsive to the NL based input and provide the content to the NL based response system 120, which the NL based response system 120 may cause to be rendered at the client device 110 or a different client device. In some examples, the NL based response system 120 may request content responsive to the NL based input from the one or more search engines 182 and/or one or more ML models stored in the ML model database(s) 180 in response to a determination (e.g. by the triggering engine 145) that a structured LLM query is not to be generated using the structured LLM query engine 130, with the request for content from the one or more search engines 182 and/or one or more ML models being sent in lieu of generating a structured LLM query and processing the structured LLM query using the LLM of the LLM database 175. In other examples, the NL based response system 120 may request content responsive to the NL based input from the one or more search engines and/or one or more ML models in response to a determination (e.g. by the response engine 150) that an NL based input is grammatically correct.

In some instances, one or more of the systems and/or methods disclosed herein can be used as part of a system and/or method for conducting a dialog (e.g., including multiple inputs and responses) with a human user. For instance, the NL based response system 120 can be provided as part of an automated assistant, a chat bot, etc. In some cases, the user can provide one or more commands to be fulfilled as part of the dialog (e.g., to control a smart device, to generate code, to generate commands to control a robot 190 in communication with the NL based response system 120, to assist with navigation in a vehicle, etc.). For example, a user may provide the client device 110 with natural language based input for controlling a smart device, controlling a robot 190, or controlling a vehicle. The NL based input may be processed using an LLM, as described herein, to generate an LLM response comprising content which can be used to control the smart device, control the robot 190, or control the vehicle. For example, FIG. 1 shows the NL based response system 120 interfacing with a robot 190, wherein an LLM response generated by the NL based response system 120 in accordance with one or more implementations described herein may be used to control the robot 190. For example, the LLM response, or a portion thereof, may be transmitted to the robot 190 and processed by the robot 190 to generate one or more commands for controlling one or more actuators of the robot 190 (e.g. to cause the robot 190 to navigate to a location).

While FIG. 1 shows the NL based response system 120 interfacing with a robot 190, this is merely shown by way of example. It should be understood that in other examples the NL based response system 120 is not interfacing with a robot 190, or the NL based response system 120 may instead be interfacing with one or more of a vehicle control system, a smart device, or the like. Furthermore, in some examples the client device 110 and/or NL based response system 120 may be comprised in the robot 190, the vehicle, the smart device, or the like.

Although aspects of FIG. 1 are illustrated or described with respect to a single client device 110 having a single user, it should be understood that such an illustration and description are for the sake of example and are not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices can be in communication with the client device 110 (e.g., over the network(s) 199). As another example, a given client device can be utilized by multiple users in a shared setting (e.g., a group of users, a household, a workplace, a hotel, etc.).

Additional description of the various engines and/or sub-engines of the client device 110 and the NL based response system 120 is provided herein with respect to FIGS. 2, 3, 4A, 4B, 5A, 5B, 6A, 6B, 7 and 8.

Turning now to FIG. 2, there is depicted an example process flow 200 of utilizing a large language model (LLM) to determine whether an NL based input is grammatically incorrect and, if so, causing a feedback output to be rendered to notify a user of the grammatically incorrect NL based input. The process flow 200 may utilize a NL based response system (e.g., the NL based response system 120 from FIG. 1).

As discussed herein, an NL based input 210 can be received by the NL based response system 120. The NL based input 210 can be provided to the NL based response system 120, for example in order to obtain content responsive to the NL based input 210. In some implementations, the NL based input 210 can include an intent to complete a particular task, for instance, to be fulfilled by an automated assistant and/or robot 190 that is communicatively coupled to the NL based response system 120 (e.g., via the network(s) 199). In additional or alternative implementations, the NL based input 210 can include a query for information that is responsive to the query.

The user can provide the NL based input 210 by, for instance, providing speech which is captured by one or more microphones of the client device 110, typing on a virtual or physical keyboard of the client device 110, providing gestures captured by one or more sensors of the client device 110, etc. Information indicative of the user input can be used to determine the NL based input 210. For instance, the information can include text entered, selected, or determined based on processing the user's speech using speech recognition. This text can then be provided as the NL based input 210. For the sake of example, a spoken utterance may be received from a user via a computing device (e.g., the computing device 110 of FIG. 1). The spoken utterance can be captured in audio data, and a user input engine 112 can process the audio data to generate NL based input 210 (e.g., using automatic speech recognition (ASR) model(s), natural language understanding (NLU) model(s), speaker identification model(s), and/or other models).

A structured LLM query 220 may be generated by the NL based response system 120 by processing the NL based input 210 (e.g., using the structured LLM query engine 130). The LLM query 220 comprises an LLM prompt to cause an LLM (e.g., an LLM stored in the LLM(s) database 175) to generate an LLM response 230 that includes an indication of whether the NL based input 210 is grammatically incorrect. For example, the LLM prompt may comprise an NL request (e.g. a NL text string) to prompt the LLM to provide an LLM response 230 that indicates whether the NL based input 210 is grammatically incorrect. In some implementations, the LLM prompt of the LLM query 220 may include an indication of the format in which the LLM response 230 should be provided by the LLM. The structured LLM query engine 130 may generate the LLM query 220 by prepending the LLM prompt to the NL based input 210, or combining the LLM prompt with the NL based input 210 in any other suitable manner, such as appending the LLM prompt to the NL based input 210.

In some examples, the LLM prompt may be a predetermined prompt that has been determined prior to receiving the NL based input 210. For example, the LLM prompt may have been stored in a memory of the NL based response system 120 prior to receipt of the NL based input 210.

In some examples, the indication in the LLM response 230 is indicative of at least one of a relative importance of a grammatical error identified in the NL based input 210, a location of a grammatical error identified in the NL based input 210, and/or a type of grammatical error identified in the NL based input 210.

In some examples, the indication in the LLM response 230 comprises a numerical error value, the numerical error value corresponding to whether the NL based input 210 is grammatically incorrect. For example, an error value of “1” in the LLM response 230 may correspond to the NL based input 210 being determined to be grammatically incorrect, whereas an error value of “0” in the LLM response 230 may correspond to the NL based input 210 being determined to be grammatically correct. In some examples, the magnitude of the error value may be indicative of a relative importance or severity of at least one grammatical error contained in the NL based input (e.g., a value of “0.2” may correspond to a grammatical error of relatively low severity whereas a value of “0.9” may correspond to a grammatical error of relatively high severity). These numerical error values are merely provided by way of example and it is envisaged that other error values can be used.

In some examples, the indication of whether the NL based input is grammatically incorrect comprises an indication of whether a word in the NL based input is grammatically incorrect. Additionally, or alternatively, in some examples the indication of whether the NL based input is grammatically incorrect comprises an indication of whether a sentence in the NL based input is grammatically incorrect.

As an example of generating an LLM query 220, the structured LLM query engine 130 may prepend the LLM prompt of “Check if the following query is grammatically correct. If so, type in the Boolean 0. If not, make and surface the grammatically correct sentence and type in Boolean 1. Query=” to a grammatically incorrect NL based input 210 of “What are the capital of Kentucky?” to generate the LLM query 220 of “Check if the following query is grammatically correct. If so, type in the Boolean 0. If not, make and surface the grammatically correct sentence and type in Boolean 1. Query=What are the capital of Kentucky?”. It should be understood that this is merely an example, and that alternative forms of LLM prompt and/or LLM query 220 may be generated instead.

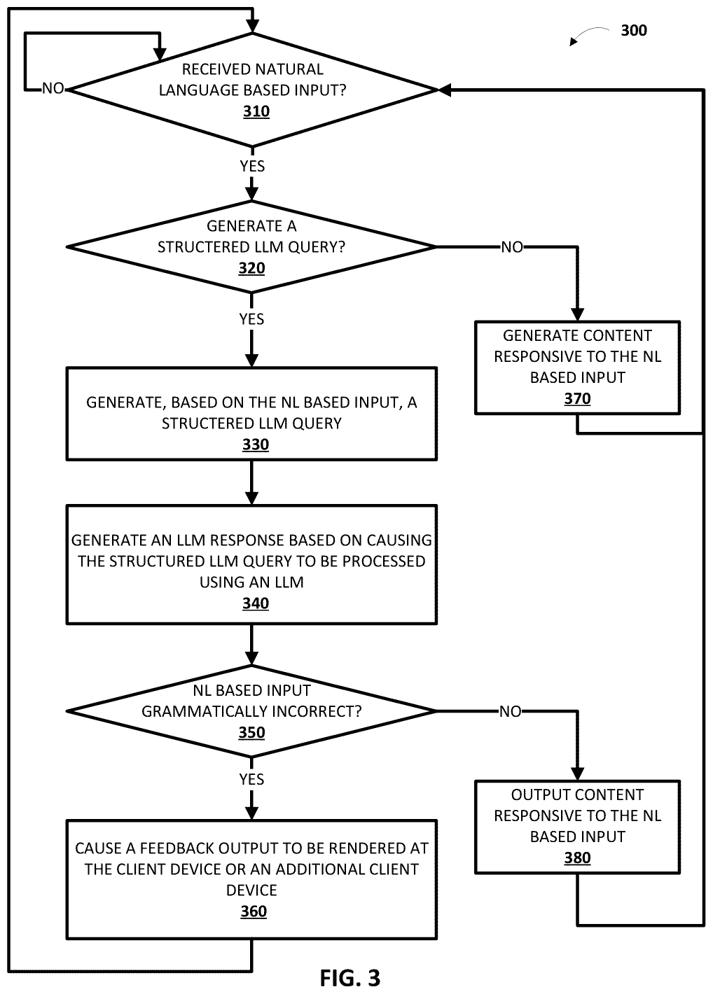

In some implementations, prior to generating the structured LLM query 220, the NL based response system 120 may have determined (e.g., using the triggering engine 145) whether to generate the structured LLM query 220. Responsive to determining that a structured LLM query 220 should be generated, the structured LLM query engine 130 is caused to generate the structured LLM query 220. On the other hand, responsive to determining that a structured LLM query 220 should not be generated, the NL based response system 120 may take an action in lieu of generating a structured LLM query 220, for example as described later in relation to FIG. 3.

After generation of the structured LLM query 220, the LLM engine 140 of the NL based response system 120 causes the structured LLM query 220 to be processed using an LLM (e.g., of the LLM(s) database 175) to generate an LLM response 230. The LLM receives the structured LLM query 220 generated by the structured LLM query engine 130 and processes the structured LLM query 220 to generate the LLM response 230, which is provided to the response engine 150 of the NL based response system 120. The LLM response 230 includes an indication of whether the NL based input 210 is grammatically incorrect, due to the presence of the LLM prompt included in the LLM query 220 causing the LLM to generate an LLM response including such an indication. The indication of whether the NL based input 120 is grammatically incorrect may be of a type and/or format that was specified by the prompt of the LLM query 220.

The response engine 150 of the NL based response system 120 processes the LLM response 230 received from the LLM to determine whether the indication included in the LLM response 230 is indicative of the NL based input 210 being grammatically incorrect. For example, in some implementations the LLM response 230 is parsed by a response parsing engine 152 of the response engine 150 to identify the indication and an evaluation engine 154 determines, based on the indication identified by the response parsing engine 152, whether to cause a feedback output 240 to be rendered by the client device 110 or another client device.

In scenarios in which it is determined to cause the feedback output 240 to be rendered, a temporal engine 156 of the response engine 150 may determine an appropriate time at which to cause the feedback output 240 to be rendered.

In response to a positive determination by the response engine 150 that the indication contained in the LLM response 230 is indicative of the NL based input being grammatically incorrect, the response engine 150 causes the feedback output 240 to be rendered, for example using the rendering engine 114 of the client device 110, or a rendering engine of a different client device. For example, the response engine 150 may transmit data to the client device 110 (or another client device) that is operable to cause the client device 110 (or the other client device) to render the feedback output 240 using one or more output devices such as one or more speakers 115, display(s) 116 and/or light source(s) 117.

In some examples, wherein the indication in the LLM response 230 comprises an error value, the error value being indicative of a relative importance of at least one grammatical error contained in the NL based input 210, causing the feedback output 240 to be rendered may be based on a magnitude of the error value. For example, in some instances, a feedback output 240 may only be caused to be rendered if the magnitude of the feedback value exceeds a threshold (e.g., is greater than 0.5). Additionally, or alternatively, in some instances, the type of feedback output 240 caused to be rendered may be determined based on the error value, such as the magnitude of the error value. For example, the evaluation engine 154 may determine to cause a visual feedback output to be rendered if the error value meets a first threshold value, and instead (or additionally) cause an audible feedback output to be rendered if the error value meets a second threshold value (which may, for example, be greater than the first threshold value).

Although it has generally been described that the client device 110 to which the NL based input 210 is associated and the client device 110 which renders the feedback output 240 are the same client device 110, in some implementations this may not be the case. In other words, the client device 110 caused to render the feedback output 240 can be a different client device than the client device 110 which provided the NL based input 210. For instance, the feedback output 240 can be caused to be rendered using a speaker(s) separate from (but possibly associated with, for instance, by virtue of a user account being signed in on both devices) a smart speaker through which the NL based input 210 was provided.

In this way, the NL based response system 120 can be utilized to detect grammatical errors in an NL based input 210 associated with a client device 110 and cause rendering of an indication of the grammatical error by the client device 110. In other words, the NL based response system 120 described herein can be utilized to notify a user that an NL based input 210 provided by the user using a client device 110 is grammatically incorrect, allowing the user to take corrective action if necessary, for example by providing a subsequent NL based input that is grammatically correct.

Although the process flow 200 of FIG. 2 is depicted as including a particular flow, it should be understood that the particular flow is for the sake of example to illustrate various aspects of the NL based response system 120 and is not meant to be limiting.

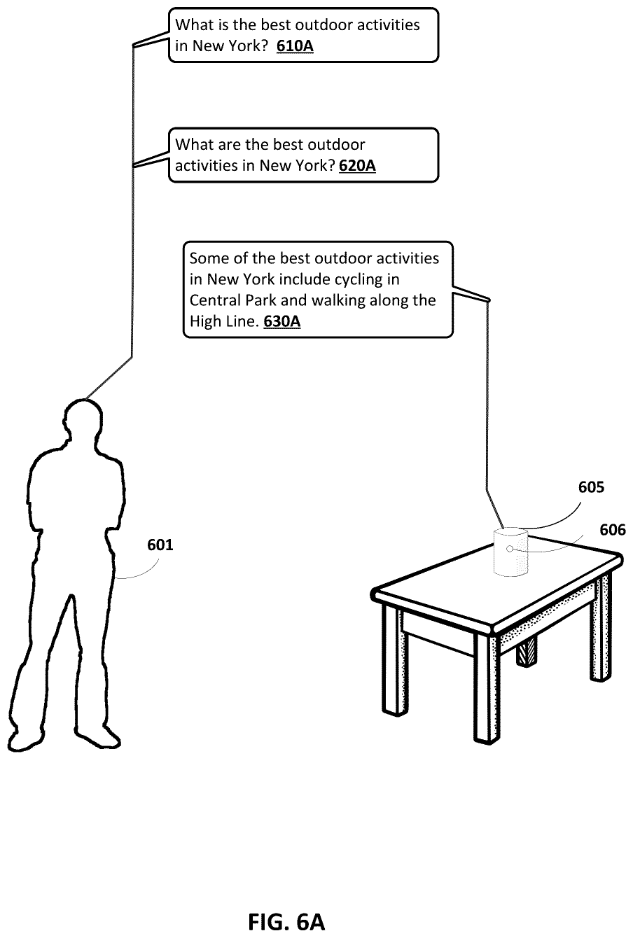

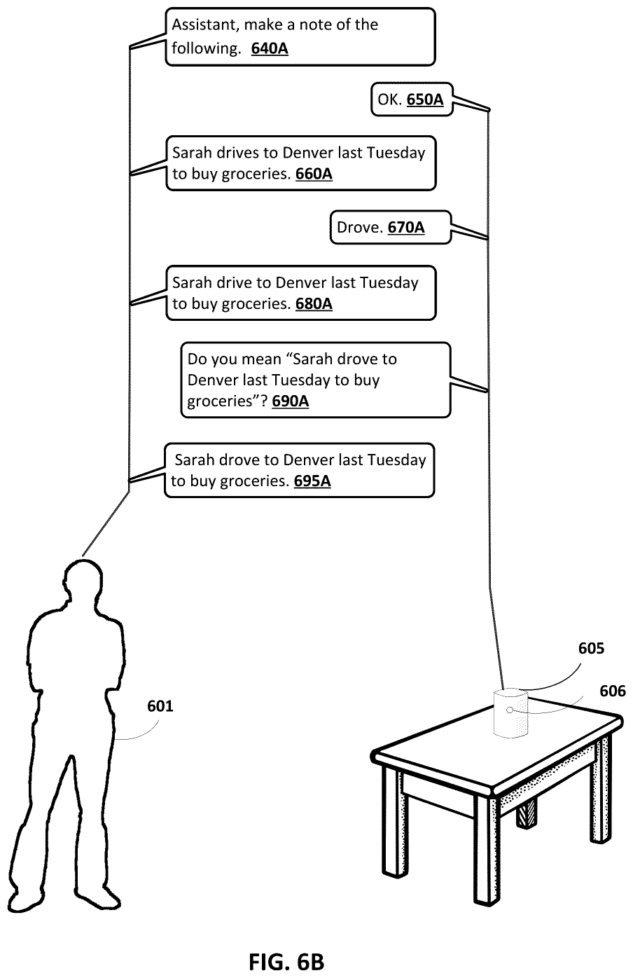

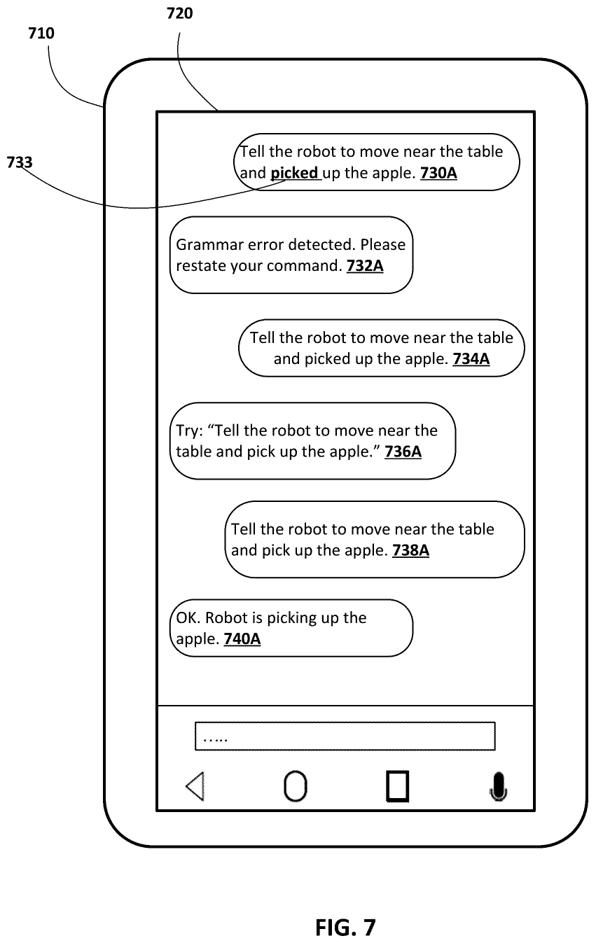

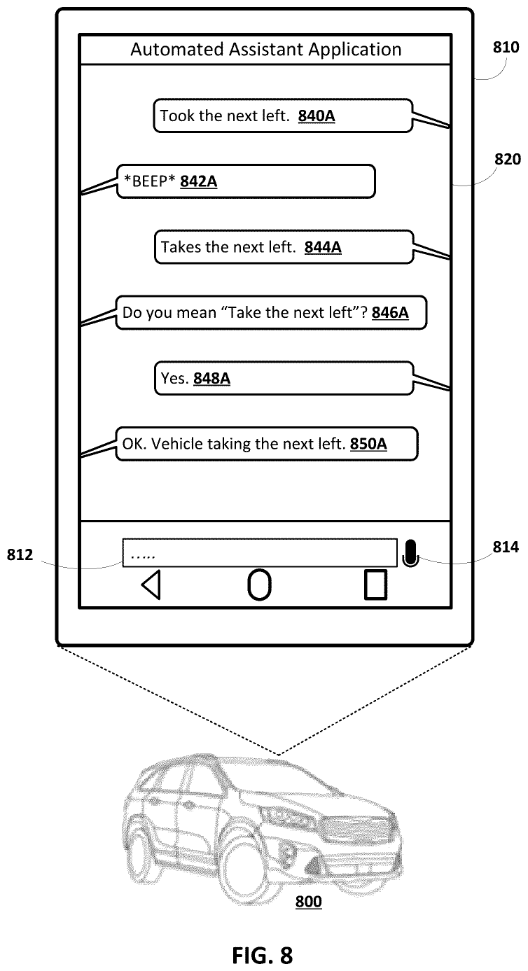

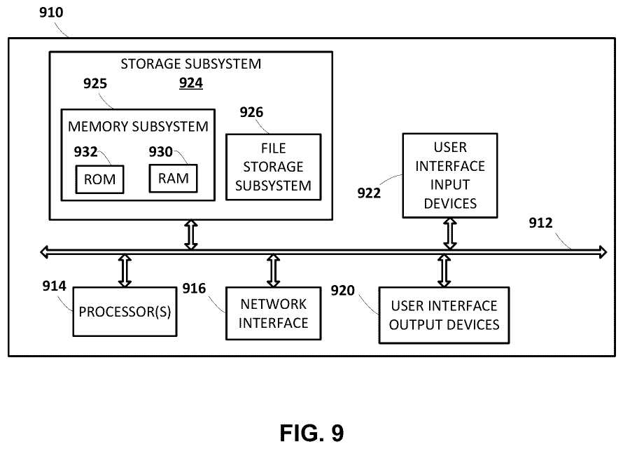

Turning now to FIG. 3, a flowchart illustrating an example method 300 of utilizing an NL based response system (e.g., the NL based response system 120 of FIG. 1) to detect and indicate whether an NL based input is grammatically incorrect, in accordance with various implementations, is depicted. For convenience, the operations of the method 300 are described with reference to a system that performs the operations. This system of the method 300 includes one or more processors, memory, and/or other component(s) of computing device(s) (e.g., client device 110 of FIG. 1, NL based response system 120 of FIG. 1 or FIG. 2, client device 605 of FIG. 6A, client device 605 of FIG. 6B, client device 710 of FIG. 7, client device 810 of FIG. 8, computing device 910 of FIG. 9, one or more servers, and/or other computing devices). Moreover, while operations of the method 300 are shown in a particular order, this is not meant to be limiting. One or more operations may be reordered, omitted, and/or added.

At block 310, the system determines whether a natural language (NL) based input associated with a client device has been received. If, at an iteration of block 310, the system determines that an NL based input has not been received, then the system can continue monitoring whether an NL based input has been received at block 310. If, at an iteration of block 310, the system determines that an NL based input has been received, then the system can proceed to block 320.

At block 320, the system determines (e.g., using a triggering engine 145) whether to generate a structured large language model (LLM) query, the structured LLM query comprising a prompt to cause an LLM (e.g., an LLM stored in the LLM(s) database 175) to generate an LLM response that includes an indication of whether the NL based input is grammatically incorrect. The system can determine whether to generate a structured large language model (LLM) query based on, for example, one or more of the conditions described in relation to the triggering engine 145 of FIG. 1.

If, at block 320, it is determined that a structured LLM query should not be generated, the system may perform a further action in lieu of generating the structured LLM query based on the NL based input. For example, the method 300 may proceed to block 370 in which the system causes content that is responsive to the NL based input to be generated and, in some examples, rendered. For example, performing a further action may involve causing one or more machine learning models (such as one or machine learning models stored in the ML model(s) database 180 of FIG. 1, or the LLM utilized in block 340) to generate content responsive to the NL based input by processing the NL based input. The system may then cause the generated content (such as NL content) to be rendered, for example by the client device associated with the NL based input or a different client device. The method 300 may then return to block 310. If at block 320 the system instead determines to generate a structured LLM query, then the system can proceed to block 330.

At block 330, and responsive to a determination at block 320 that a structured LLM query should be generated, the system generates (e.g., as described with respect to the process flow of FIG. 2), and based on the NL based input, the structured LLM query. The system can generate the structured LLM query by transforming the NL based input into a structured format that can be processed by an LLM (e.g., the LLM that is fine-tuned as described above with respect to FIG. 1). The structured LLM query comprises an LLM prompt to cause the LLM to generate an LLM response that includes an indication of whether the NL based input is grammatically incorrect (i.e. whether the NL based input contains at least one grammatical error). As an example, generating a structured LLM query may comprise prepending an NL LLM prompt of “Check if the following query is grammatically correct. If so, start your response with 0. If not, start your response with 1. Query=” to a grammatically incorrect NL based input of “How many state are there in the U.S.A?” to generate a structured LLM query of “Check if the following query is grammatically correct. If so, start your response with 0. If not, start your response with 1. Query=How many state are there in the U.S.A?”. These examples of an LLM prompt, an NL based input and an LLM query are merely provided as illustrations and are not meant to be limiting. The LLM prompt, NL based input and/or LLM query may take alternative forms to those described herein and/or may be combined in an alternative manner. For example, rather than prepending the LLM prompt to the beginning of the NL based input, in other examples the LLM prompt may be appended to the end of the NL based input to form the LLM query. In yet another example, the NL based input may be inserted within the LLM prompt such that parts of the LLM prompt bookend either side of the NL based input.

In some examples, the system may utilize additional data in generating the structured LLM query. For example, the system can obtain and/or generate (e.g. using the context engine 160) contextual data that is associated with the user of the client device, the client device itself, and/or other contextual data. Based on the contextual data, the system may generate the structured LLM query, for example by incorporating the contextual data into the structured LLM query.

At block 340, the system generates, based on processing (e.g., as described with respect to the process flow of FIG. 2) the structured LLM query generated in block 330, an LLM response that includes an indication of whether the NL based input is grammatically incorrect. The LLM prompt in the structured LLM query has prompted the LLM to provide the indication of whether the NL based input is grammatically incorrect in its output. For the example structured LLM query of “Check if the following query is grammatically correct. If so, start your response with 0. If not, start your response with 1. Query=How many state are there in the U.S.A?”, an example of an LLM response output by the LLM may be “1 There are fifty states in the U.S.A.”, where the “1” at the beginning of the LLM response is the indication that the NL based input is grammatically incorrect. In this example, the LLM has also provided in the LLM response NL content of “There are fifty states in the U.S.A.” that is responsive to the NL based input.

At block 350, the system determines whether the NL based input is grammatically incorrect based on processing the LLM response (and in particular the indication contained in the LLM response) that was generated in block 340. For example, a response parsing engine 152 may parse the LLM response received from the LLM to identify the indication included in the LLM response and an evaluation engine 154 may determine, based on the indication identified by the response parsing engine 152, whether the NL based input is grammatically incorrect. As a non-limiting example, for the example NL LLM response of “1 There are fifty states in the U.S.A”, the parsing engine 152 may identify the indication of “1” at the beginning of the LLM response. Based on processing the identified indication of “1” (rather than “0”), the evaluation engine 154 may determine that the NL based input is grammatically incorrect.

At block 360, and responsive to a determination at block 350 that the NL based input is grammatically incorrect, the system causes a feedback output to be rendered at the client device or an additional client device (e.g., as described with respect to the process flow of FIG. 2). For example, the system may transmit data to the client device (or the additional client device) that is operable to cause the client device (or the additional client device) to render the feedback output. The feedback output is rendered to indicate to a user that the NL based input is grammatically incorrect. Following block 360, the method 300 may return to block 310 at which the system awaits receipt of a new NL based input to process.

If, at block 350, it is determined that the NL based input is not grammatically incorrect (i.e. the NL based input is grammatically correct), the system may in some examples cause content responsive to the NL based input to be output at block 380, in lieu of causing the feedback output to be rendered. For example, where the NL based input comprised a query for information, the LLM response generated at block 340 may comprise content responsive to the query for information, wherein the system may cause this content to be output (e.g. by the client device or another client device) at block 380. In the example where the LLM has provided in the LLM response NL content of “There are fifty states in the U.S.A.”, the system may cause that NL content (or a portion thereof) to be rendered, for example audibly rendered using one or more speakers of the client device or visibly rendered using a display of the client device. The method 300 may then return to block 310.

It should be noted that in some examples, block 320 may be omitted from the method 300, with the method moving from block 310 to block 330 without block 320. That is, after a NL based input is received in block 310, at block 330 the system generates a structured LLM query based on the NL based input without first determining whether to generate the structured LLM query.

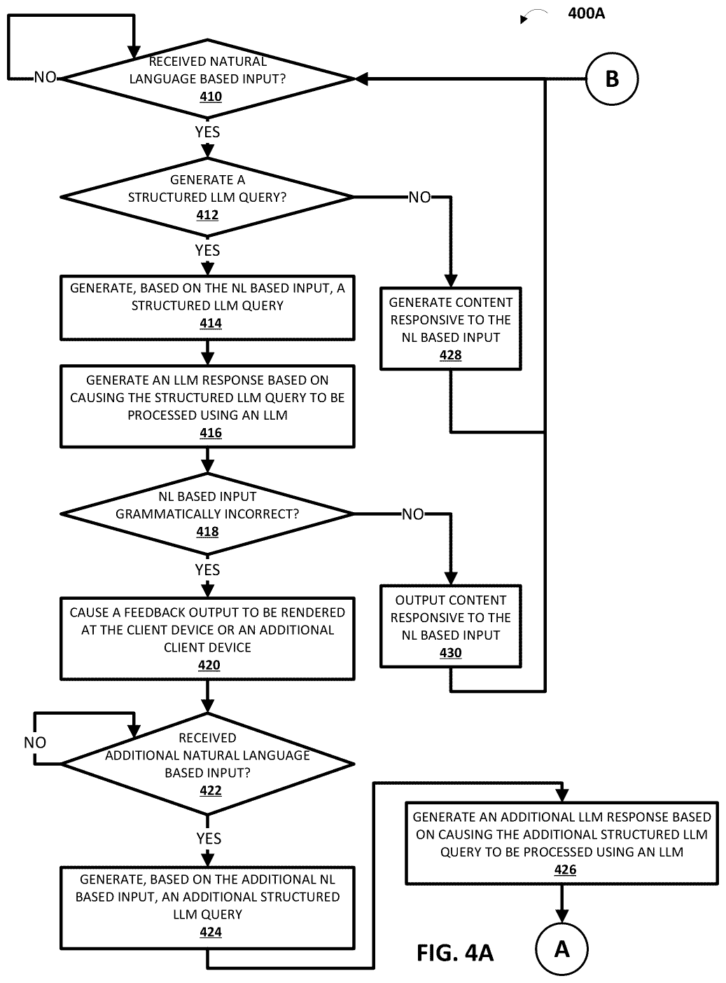

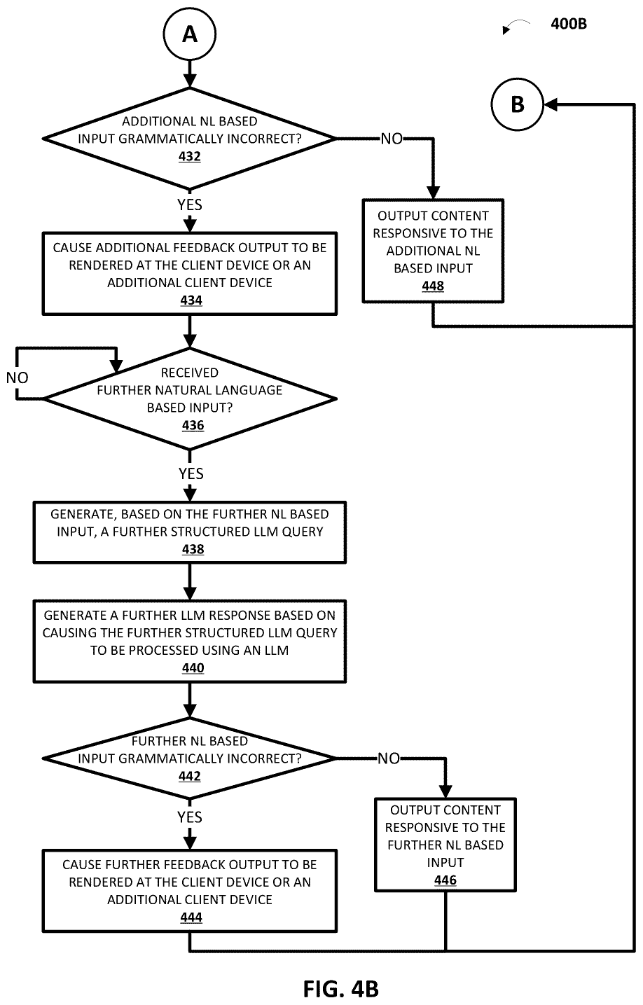

Turning now to FIG. 4A and FIG. 4B, a flowchart illustrating an example method 400A, 400B of utilizing an NL based response system (e.g., a NL based response system 120 of FIG. 1) to detect and indicate whether an NL based input is grammatically correct, in accordance with various implementations, is depicted. For convenience, the operations of the method 400A, 400B are described with reference to a system that performs the operations. This system of the method 400A, 400B includes one or more processors, memory, and/or other component(s) of computing device(s) (e.g., client device 110 of FIG. 1, NL based response system 120 of FIG. 1 or FIG. 2, client device 605 of FIG. 6A, client device 605 of FIG. 6B, client device 710 of FIG. 7, client device 810 of FIG. 8, computing device 910 of FIG. 9, one or more servers, and/or other computing devices). Moreover, while operations of the method 400A, 400B are shown in a particular order, this is not meant to be limiting. One or more operations may be reordered, omitted, and/or added.

At block 410, the system determines whether a natural language (NL) based input associated with a client device has been received, in a similar manner as described previously in relation to block 310 of FIG. 3. If, at an iteration of block 410, the system determines that an NL based input has not been received, then the system can continue monitoring whether an NL based input has been received at block 410. If, at an iteration of block 410, the system determines that an NL based input has been received, then the system can proceed to block 412.

At block 412, the system determines whether to generate a structured large language model (LLM) query, the structured LLM query comprising a prompt to cause an LLM (e.g., an LLM stored in the LLM(s) database 175) to generate an LLM response that includes an indication of whether the NL based input is grammatically incorrect. The system can determine whether to generate a structured large language model (LLM) query in accordance with any suitable method described herein, for example in relation to block 320 of FIG. 3.

If, at block 412, it is determined that a structured LLM query should not be generated, the system may perform a further action in lieu of generating the structured LLM query based on the NL based input. For example, the method 400A may proceed to block 428 in which the system causes content that is responsive to the NL based input to be generated and rendered. In some examples, this may involve causing one or more machine learning models (such as one or machine learning models stored in the ML model(s) database 180 of FIG. 1, or the LLM utilized in block 416) to generate content responsive to the NL based input by processing the NL based input. The system may then cause the generated content to be rendered, for example by the client device associated with the NL based input or a different client device. The method 400A may then return to block 410. If at block 412 the system instead determines to generate a structured LLM query, then the system can proceed to block 414.

At block 414, and responsive to a determination at block 412 that a structured LLM query should be generated, the system generates (e.g., as described with respect to the process flow of FIG. 2), and based on the NL based input, the structured LLM query. The system can generate the structured LLM query by transforming the NL based input into a structured format that can be processed by an LLM (e.g., the LLM that is fine-tuned as described above with respect to FIG. 1). The structured LLM query comprises an LLM prompt to cause the LLM to generate an LLM response that includes an indication of whether the NL based input is grammatically incorrect (i.e. whether the NL based input contains at least one grammatical error).

At block 416, the system generates, based on processing (e.g., as described with respect to the process flow of FIG. 2) the structured LLM query generated in block 414, an LLM response that includes an indication of whether the NL based input is grammatically incorrect. The LLM prompt in the structured LLM query has prompted the LLM to provide the indication of whether the NL based input is grammatically incorrect in its output.

At block 418, the system determines whether the NL based input is grammatically incorrect based on processing the LLM response (and in particular the indication contained in the LLM response) that was generated in block 416. For example, a response parsing engine 152 may parse the LLM response received from the LLM to identify the indication included in the LLM response and an evaluation engine 154 may determine, based on the indication identified by the response parsing engine 152, whether the NL based input is grammatically incorrect.

At block 420, and responsive to a determination at block 418 that the NL based input is grammatically incorrect, the system causes a feedback output to be rendered at the client device or an additional client device (e.g., as described with respect to the process flow of FIG. 2). For example, the system may transmit a signal to the client device (or the additional client device) that is operable to cause the client device (or the additional client device) to render the feedback output. The feedback output is rendered to indicate to a user that the NL based input is grammatically incorrect. Following block 420, the method 400A proceeds to block 422.

If, at block 418, it is determined that the NL based input is not grammatically incorrect (i.e. the NL based input is grammatically correct), the system may in some examples cause content responsive to the NL based input to be output at block 430, in lieu of causing the feedback output to be rendered. For example, where the NL based input comprised a query for information, the LLM response generated at block 416 may comprise content responsive to the query for information, wherein the system may cause this content to be rendered (e.g. by the client device or another client device) at block 430. The method 400A may then return to block 410.

At block 422, the system determines whether a new NL based input (hereafter an additional NL based input) has been received. The additional NL based input may be provided by the same user that provided the previous NL based input at block 410. The additional NL based input may be provided via the same client device as before, the additional client device, or a different client device that interfaces with the NL based response system 120. The additional NL based input may be an attempt by the user to provide a grammatically correct version of the NL based input received at block 410.

If, at an iteration of block 422, the system determines that an additional NL based input has not been received, then the system can continue monitoring whether an additional NL based input has been received at block 422. If, at an iteration of block 422, the system determines that an additional NL based input has been received, then the system can proceed to block 424.

In some examples, the system may continue monitoring for an additional NL based input at block 422 until either an additional NL based input is received or a timer expires. If no additional NL based input has been received before the timer expires, the system may return to block 410. Additionally, or alternatively, in some examples, the system may continue monitoring for an additional NL based input at block 422 until an input (that is not an additional NL based input) is received, for example a user input indicating that monitoring for an additional NL based input should be ceased.

At block 424, and in response to a determination at block 422 that an additional NL based input has been received, the system generates (e.g., as described with respect to the process flow of FIG. 2), based on the additional NL based input, an additional structured LLM query. Generating the additional structured LLM query may be performed in a similar manner to generating a structured LLM query in block 414. The system can generate the additional structured LLM query by transforming the additional NL based input into a structured format that can be processed by an LLM (e.g., the LLM that is fine-tuned as described above with respect to FIG. 1). The additional structured LLM query comprises an LLM prompt to cause the LLM to generate an additional LLM response that includes an indication of whether the additional NL based input is grammatically incorrect (i.e. whether the additional NL based input contains at least one grammatical error). The LLM prompt may be the same as the LLM prompt included in the structured LLM query generated at block 414.

At block 426, the system generates an additional LLM response based on causing the additional structured LLM query generated at block 424 to be processed using an LLM, wherein the LLM may be the same LLM used to generate the LLM response at block 416, or it may be a different LLM (e.g. stored in the LLM database 175 of FIG. 1). The LLM prompt in the additional structured LLM query has prompted the LLM to provide in the additional LLM response an indication of whether the additional NL based input is grammatically incorrect.

Following block 426 shown in FIG. 4A, the method 400A proceeds to block 432 shown in the method 400B of FIG. 4B. At block 432, the system determines whether the additional NL based input is grammatically incorrect based on processing the additional LLM response (and in particular the indication contained in the additional LLM response) that was generated in block 426. For example, the response parsing engine 152 may parse the additional LLM response received from the LLM to identify the indication included in the additional LLM response and the evaluation engine 154 may determine, based on the indication identified by the response parsing engine 152, whether the NL based input is grammatically incorrect.

At block 434, and in response to a determination at block 423 that the additional NL based input is grammatically incorrect, the system causes an additional feedback output to be rendered, which may be caused to be rendered in a similar manner as the feedback output 240 discussed in relation to FIG. 2, or block 420 of FIG. 4A, for example. The additional feedback output could be rendered at the client device, the additional device, or a different device that interfaces with the NL based response system. In some examples, the additional feedback output caused to be rendered at block 434 may be different to the feedback output caused to be rendered at block 420. For example, the feedback output caused to be rendered at block 420 may be a visual feedback output (for example rendered using an LED or other light source 117 of the client device) whereas the additional feedback output caused to be rendered at block 434 may be an audible feedback output (for example rendered using one or more speakers 115 of the client device 110). The method then proceeds to block 436.

If, at block 432, it is instead determined that the additional NL based input is not grammatically incorrect (i.e. the additional NL based input is grammatically correct), the system may in some examples cause content responsive to the additional NL based input to be output at block 448 in lieu of causing the additional feedback output to be rendered, using any suitable method described herein. For example, where the additional NL based input comprised a query for information, the additional LLM response generated at block 426 may comprise content responsive to the query for information, wherein the system may cause this content to be rendered (e.g. by the client device or another client device) at block 448. The method 400B may then return to block 410 in FIG. 4A. While it has been described that content responsive to the additional NL based input is rendered at block 448, in other examples content responsive to the NL based input received at block 410 may instead be rendered (e.g. by the client device or another client device) at block 448, for example where the content responsive to the NL based input was generated at block 416 as part of the LLM response.

At block 436, the system determines whether another new NL based input (hereafter a further NL based input) has been received. The further NL based input may be provided by the same user that provided the NL based input at block 410 and/or the additional NL based input at block 422. The further NL based input may be provided via the same client device as before, the additional client device, or a different client device that interfaces with the NL based response system 120. The further NL based input may be another attempt by the user to provide a grammatically correct version of the NL based input received at block 410 and/or the additional NL based input received at block 422.

If, at an iteration of block 436, the system determines that a further NL based input has not been received, then the system can continue monitoring whether a further NL based input has been received at block 436 (e.g., in a similar manner to block 410 or block 422). If, at an iteration of block 436, the system determines that a further NL based input has been received, then the system can proceed to block 438.

In some examples, the system may continue monitoring for a further NL based input at block 436 until either a further NL based input is received or a timer expires. If no further NL based input has been received before the timer expires, the system may return to block 410. Additionally, or alternatively, in some examples, the system may continue monitoring for a further NL based input at block 436 until an input (that is not a further NL based input) is received, for example a user input to stop monitoring for a further NL based input.

At block 438, and in response to a determination at block 436 that a further NL based input has been received, the system generates (e.g., as described with respect to the process flow of FIG. 2), based on the further NL based input, a further structured LLM query. Generating the further structured LLM query may be performed in a similar manner to generating a structured LLM query in block 414. The system can generate the further structured LLM query by transforming the further NL based input into a structured format that can be processed by an LLM (e.g., the LLM that is fine-tuned as described above with respect to FIG. 1). The further structured LLM query comprises an LLM prompt to cause the LLM to generate a further LLM response that includes an indication of whether the further NL based input is grammatically incorrect (i.e. whether the further NL based input contains at least one grammatical error). The LLM prompt may be the same as the LLM prompt included in the structured LLM query generated at block 414 and/or the LLM prompt included in the structured LLM query generated at block 424.

At block 440, the system generates a further LLM response based on causing the further structured LLM query generated at block 438 to be processed using an LLM, wherein the LLM may be the same LLM used to generate the LLM response at block 416 and/or the additional LLM response at block 426, or it may be a different LLM (e.g. stored in the LLM database 170 of FIG. 1). The LLM prompt in the further structured LLM query has prompted the LLM to provide in the further LLM response an indication of whether the further NL based input is grammatically incorrect.

Following block 440, at block 442 the system determines whether the further NL based input is grammatically incorrect based on processing the further LLM response (and in particular the indication contained in the further LLM response) that was generated in block 440. For example, the response parsing engine 152 may parse the further LLM response received from the LLM to identify the indication included in the further LLM response and the evaluation engine 154 may determine, based on the indication identified by the response parsing engine 152, whether the further NL based input is grammatically incorrect.

At block 444, and in response to a determination at block 442 that the further NL based input is grammatically incorrect, the system causes a further feedback output to be rendered. The further feedback output could be rendered at the client device, the additional device, or a different device that interfaces with the NL based response system 120. In some examples, the further feedback output caused to be rendered at block 444 may be different to the feedback output caused to be rendered at block 420 and/or the additional feedback output caused to be rendered at block 434. For example, the feedback output caused to be rendered at block 420 may be a visual feedback output (for example rendered using an LED or other light source 117 of the client device), the additional feedback output caused to be rendered at block 434 may be an audible feedback output (for example rendered using one or more speakers 115 of the client device 110), and the further feedback output caused to be rendered at block 444 may be an audible feedback output (for example rendered using one or more speakers 115 of the client device 110) that differs to the additional feedback output (e.g., the additional feedback output may a rendering of a single word whereas the further feedback output may be a rendering of a sentence comprising a plurality of words). After block 444, the method 400B may return to block 410 of FIG. 4A.

If, at block 442, it is determined that the further NL based input is not grammatically incorrect (i.e. the further NL based input is grammatically correct), the system may in some examples cause content responsive to the further NL based input to be output at block 446, in lieu of causing the further feedback output to be rendered. For example, where the further NL based input comprised a query for information, the further LLM response generated at block 440 may comprise content responsive to the query for information, wherein the system may cause this content to be rendered (e.g. by the client device or another client device) at block 448. The method 400B may then return to block 410 in FIG. 4A. While it has been described that content responsive to the further NL based input is rendered at block 446, in other examples content responsive to the NL based input received at block 410 may instead be rendered (e.g. by the client device or another client device) at block 446, for example where the content responsive to the NL based input was generated at block 416 as part of the LLM response, or in other examples content responsive to the additional NL based input received at block 422 may instead be rendered (e.g. by the client device or another client device) at block 446, for example where the content responsive to the additional NL based input was generated at block 426 as part of the additional LLM response.

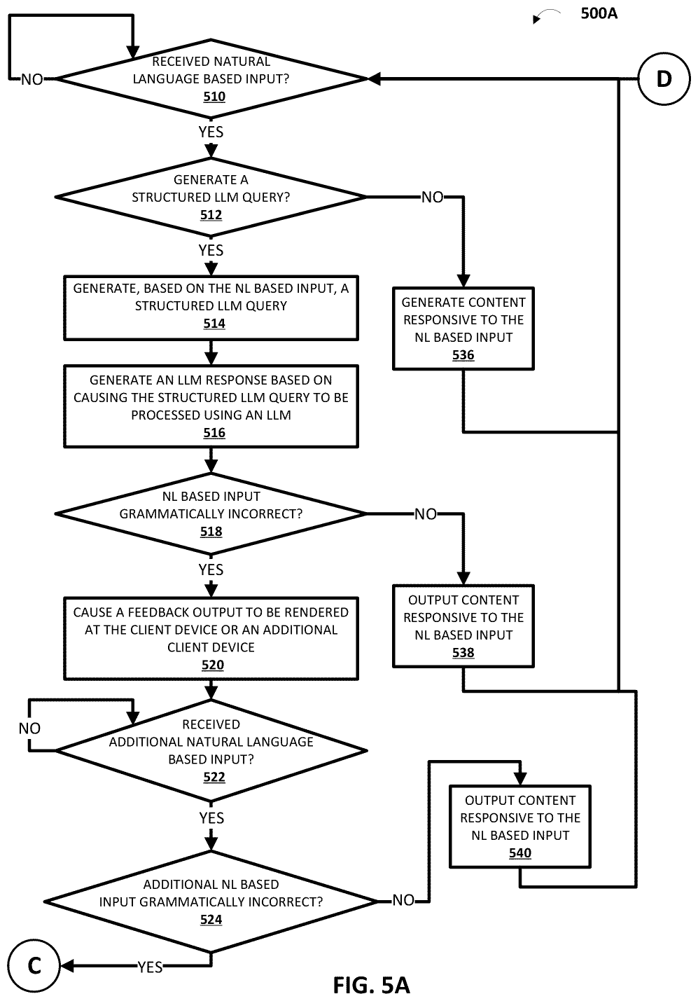

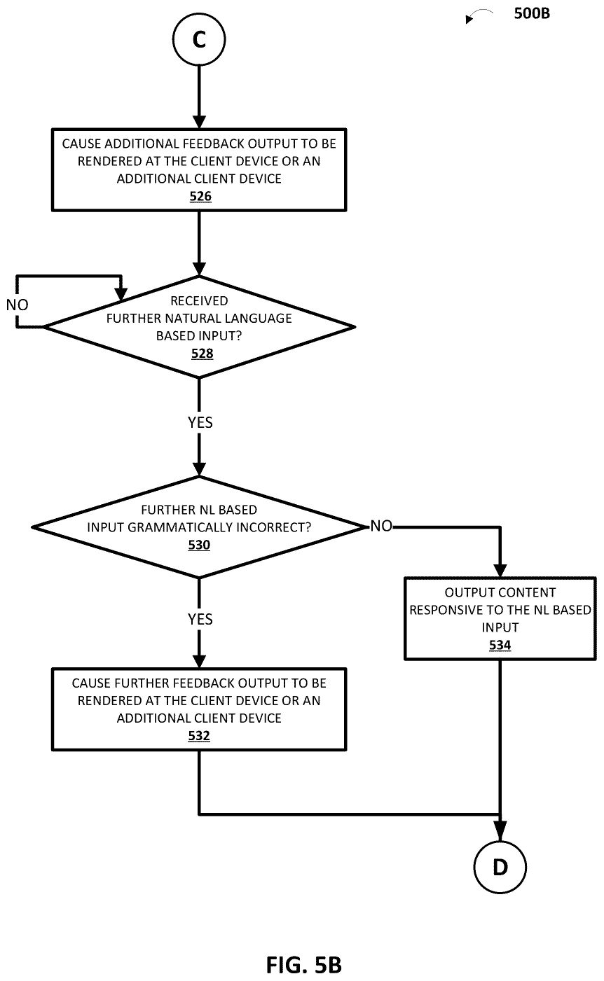

Turning now to FIG. 5A and FIG. 5B, a flowchart illustrating another example method 500A, 500B of utilizing an NL based response system (e.g., the NL based response system 120 of FIG. 1) to detect and indicate whether an NL based input is grammatically correct, in accordance with various implementations, is depicted. The method 500A, 500B of FIG. 5A and FIG. 5B is similar to the method 400A, 400B of FIGS. 4A and 4B, except for the manner in which it is determined whether the received additional NL based input and/or received further NL based input is/are grammatically correct. For convenience, the operations of the method 500A, 500B are described with reference to a system that performs the operations. This system of the method 500A, 500B includes one or more processors, memory, and/or other component(s) of computing device(s) (e.g., client device 110 of FIG. 1, NL based response system 120 of FIG. 1 or FIG. 2, client device 605 of FIG. 6A, client device 605 of FIG. 6B, client device 710 of FIG. 7, client device 810 of FIG. 8, computing device 910 of FIG. 9, one or more servers, and/or other computing devices). Moreover, while operations of the method 500A, 500B are shown in a particular order, this is not meant to be limiting. One or more operations may be reordered, omitted, and/or added.

At block 510, the system determines whether a natural language (NL) based input associated with a client device has been received. If, at an iteration of block 510, the system determines that an NL based input has not been received, then the system can continue monitoring whether an NL based input has been received at block 510. If, at an iteration of block 510, the system determines that an NL based input has been received, then the system can proceed to block 512.

At block 512, the system determines whether to generate a structured large language model (LLM) query, the structured LLM query comprising a prompt to cause an LLM (e.g., an LLM stored in the LLM(s) database 175) to generate an LLM response that includes an indication of whether the NL based input is grammatically incorrect. The system can determine whether to generate a structured large language model (LLM) query using any suitable method described herein, for example in relation to block 320 of FIG. 3.

If, at block 512, it is determined that a structured LLM query should not be generated, the system may perform a further action in lieu of generating the structured LLM query based on the NL based input, for example in a similar manner as described in relation to block 428 of FIG. 4A. For example, the method 500A may proceed to block 536 in which the system causes content that is responsive to the NL based input to be generated and rendered. In some examples, this may involve causing one or more machine learning models (such as one or machine learning models stored in the machine learning model database 180 of FIG. 1, or the LLM utilized in block 516) to generate content responsive to the NL based input by processing the NL based input. The system may then cause the generated content to be rendered, for example by the client device associated with the NL based input or a different client device. The method 500A may then return to block 510. If at block 512 the system instead determines to generate a structured LLM query, then the system can proceed to block 514.

At block 514, and responsive to a determination at block 512 that a structured LLM query should be generated, the system generates (e.g., as described with respect to the process flow of FIG. 2), and based on the NL based input, the structured LLM query. The system can generate the structured LLM query by transforming the NL based input into a structured format that can be processed by an LLM (e.g., the LLM that is fine-tuned as described above with respect to FIG. 1). The structured LLM query comprises an LLM prompt to cause the LLM to generate an LLM response that includes an indication of whether the NL based input is grammatically incorrect (i.e. whether the NL based input contains at least one grammatical error). The structured LLM query may also comprise a prompt to cause the LLM to generate, in the LLM response, a grammatically correct version of the NL based input.

At block 516, the system generates, based on processing (e.g., as described with respect to the process flow of FIG. 2) the structured LLM query generated in block 514, an LLM response that includes an indication of whether the NL based input is grammatically incorrect and a grammatically correct version of the NL based input. The structured LLM query has prompted the LLM to provide in the LLM response the indication of whether the NL based input is grammatically incorrect and the grammatically correct version of the NL based input. In some examples, the LLM query may cause the LLM to provide a grammatically correct version of the NL based input in the LLM response only if the NL based input is determined to be grammatically incorrect.

At block 518, the system determines whether the NL based input is grammatically incorrect based on processing (e.g., as described with respect to the process flow of FIG. 2) the LLM response (and in particular the indication contained in the LLM response) that was generated in block 516. For example, the response parsing engine 152 may parse the LLM response received from the LLM to identify the indication included in the LLM response and the evaluation engine 154 may determine, based on the indication identified by the response parsing engine 152, whether the NL based input is grammatically incorrect.

At block 520, and responsive to a determination at block 518 that the NL based input is grammatically incorrect, the system causes a feedback output to be rendered at the client device or an additional client device (e.g., as described with respect to the process flow of FIG. 2). For example, the system may transmit a signal to the client device (or the additional client device) that is operable to cause the client device (or the additional client device) to render the feedback output. The feedback output is rendered to indicate to a user that the NL based input is grammatically incorrect. Following block 520, the method 500A proceeds to block 522.

If, at block 518, it is determined that the NL based input is not grammatically incorrect (i.e. the NL based input is grammatically correct), the system may in some examples cause content responsive to the NL based input to be output at block 538, in lieu of causing the feedback output to be rendered. For example, where the NL based input comprised a query for information, the LLM response generated at block 516 may comprise content responsive to the query for information, wherein the system may cause this content to be rendered (e.g. by the client device or another client device) at block 538. The method 500A may then return to block 510.

At block 522, the system determines whether a new NL based input (hereafter an additional NL based input) has been received. The additional NL based input may be provided by the same user that provided the previous NL based input at block 510. The additional NL based input may be provided via the same client device as before, the additional client device, or a different client device that interfaces with the NL based response system 120. The additional NL based input may be an attempt by the user to provide a grammatically correct version of the NL based input received at block 510.

If, at an iteration of block 522, the system determines that an additional NL based input has not been received, then the system can continue monitoring whether an additional NL based input has been received at block 522. If, at an iteration of block 522, the system determines that an additional NL based input has been received, then the system can proceed to block 524.

In some examples, the system may continue monitoring for an additional NL based input at block 522 until either an additional NL based input is received or a timer expires. If no additional NL based input has been received before the timer expires, the system may return to block 510. Additionally, or alternatively, in some examples, the system may continue monitoring for an additional NL based input at block 522 until an input (that is not an additional NL based input) is received, for example a user input to stop monitoring for an additional NL based input.

At block 524, and in response to a determination at block 522 that an additional NL based input has been received, the system determines whether the additional NL based input received at block 522 is grammatically incorrect. For example, determining whether the additional NL based input received at block 522 is grammatically incorrect may comprise performing a comparison between at least a portion of the additional NL based input and at least a portion of the grammatically correct version of the NL based input generated at block 516. The additional NL based input may be determined to be grammatically incorrect based on a result of the comparison. For example, the additional NL based input may be compared to the grammatically correct version of the NL based input generated at block 516 and, if the additional NL based input differs to the grammatically correct version of the NL based input generated at block 516 (in some examples, by more than a threshold amount, such as by more than a threshold number of words), then the additional NL based input may be determined to be grammatically incorrect. It should be noted that this comparison is provided by way of illustration and that other suitable methods of comparison may be used to determine whether the additional NL based input is grammatically correct.

If it is determined at block 524 that the additional NL based input is grammatically incorrect, the method 500A proceeds to block 526 in method 500B of FIG. 5B. At block 526, and in response to a determination at block 524 that the additional NL based input is grammatically incorrect, the system causes an additional feedback output to be rendered. The additional feedback output could be rendered at the client device, the additional device, or a different device that interfaces with the NL based response system. In some examples, the additional feedback output caused to be rendered at block 526 may be different to the feedback output caused to be rendered at block 520. For example, the feedback output caused to be rendered at block 520 may be a visual feedback output (for example rendered using an LED or other light source 117 of the client device) whereas the additional feedback output caused to be rendered at block 526 may be an audible feedback output (for example rendered using one or more speakers 115 of the client device 110). The method then proceeds to block 528.

If, at block 524, it is instead determined that the additional NL based input is not grammatically incorrect (i.e. the additional NL based input is grammatically correct), the system may in some examples cause content responsive to the additional NL based input to be output at block 540, in lieu of causing the additional feedback output to be rendered at block 526. For example, the system may provide the additional NL based input (or a part thereof) as an input to one or more of an LLM (e.g., as stored in LLM(s) database 175), an ML model (e.g., as stored in ML model(s) database 180) or a search engine(s) 182, for causing the LLM, ML model and/or search engine to provide as an output content that is responsive to the additional NL based input, which content may be caused to be rendered (e.g. at the client device or an additional client device) or be used to control one or more actuators of a robot 190 (e.g., where the content comprises one or more instructions for controlling the robot 190). While it has been described that content responsive to the additional NL based input is output at block 540, in other examples content responsive to the NL based input received at block 510 may instead be output (e.g. by the client device or another client device) at block 540.

At block 528, the system determines whether another new NL based input (hereafter a further NL based input) has been received. The further NL based input may be provided by the same user that provided the NL based input at block 510 and/or the additional NL based input at block 522. The further NL based input may be provided via the same client device as before, the additional client device, or a different client device that interfaces with the NL based response system 120. The further NL based input may be another attempt by the user to provide a grammatically correct version of the NL based input received at block 510 and/or the additional NL based input received at block 522.

If, at an iteration of block 528, the system determines that a further NL based input has not been received, then the system can continue monitoring whether a further NL based input has been received at block 528. If, at an iteration of block 528, the system determines that a further NL based input has been received, then the system can proceed to block 530.

In some examples, the system may continue monitoring for a further NL based input at block 528 until either a further NL based input is received or a timer expires. If no further NL based input has been received before the timer expires, the system may return to block 510. Additionally, or alternatively, in some examples, the system may continue monitoring for a further NL based input at block 528 until an input (that is not a further NL based input) is received, for example a user input to stop monitoring for a further NL based input.

At block 530, and in response to a determination at block 528 that a further NL based input has been received, the system determines whether the additional NL based input received at block 528 is grammatically incorrect. For example, determining whether the additional NL based input received at block 528 is grammatically incorrect may comprise performing a comparison between at least a portion of the further NL based input and at least a portion of the grammatically correct version of the NL based input generated at block 516 (or at least a portion of a grammatically correct version of the additional NL based input generated using the LLM). The further NL based input may be determined to be grammatically incorrect based on a result of the comparison. For example, the further NL based input may be compared to the grammatically correct version of the NL based input generated at block 516 and, if the further NL based input differs to the grammatically correct version of the NL based input generated at block 516 (in some examples, by more than a threshold amount, such as by more than a threshold number of words), then the further NL based input may be determined to be grammatically incorrect. It should be noted that this comparison is provided by way of illustration and that other suitable methods of comparison may be used to determine whether the further NL based input is grammatically correct.

If it is determined at block 530 that the additional NL based input is grammatically incorrect, the method 500A proceeds to block 532 at which the system causes a further feedback output to be rendered. The further feedback output could be rendered at the client device, the additional device, or a different device that interfaces with the NL based response system 120. In some examples, the further feedback output caused to be rendered at block 532 may be different to the feedback output caused to be rendered at block 520 and/or the additional feedback output caused to be rendered at block 526. For example, the feedback output caused to be rendered at block 520 may be a visual feedback output (for example rendered using an LED or other light source 117 of the client device), the additional feedback output caused to be rendered at block 526 may be an audible feedback output (for example rendered using one or more speakers 115 of the client device 110), and the further feedback output caused to be rendered at block 532 may be an audible feedback output (for example rendered using one or more speakers 115 of the client device 110) that differs to the additional feedback output (e.g., the additional feedback output is a rendering of a single word whereas the further feedback output is a rendering of a sentence comprising a plurality of words). After block 532, the method 500B may return to block 510 of FIG. 5A.

If, at block 530, it is instead determined that the further NL based input is not grammatically incorrect (i.e. the additional NL based input is grammatically correct), the system may in some examples cause content responsive to the further NL based input to be output at block 534, in lieu of causing the further feedback output to be rendered at block 532. For example, the system may provide the further NL based input (or a part thereof) as an input to one or more of an LLM (e.g., as stored in LLM(s) database 175), an ML model (e.g., as stored in ML model(s) database 180) or a search engine(s) 182, for causing the LLM, ML model and/or search engine to provide as an output content that is responsive to the further NL based input, which content may be caused to be rendered (e.g. at the client device or an additional client device) or be used to control one or more actuators of a robot 190 (e.g., where the content comprises one or more instructions for a robot 190). While it has been described that content responsive to the further NL based input is output at block 534, in other examples content responsive to the NL based input received at block 510 may instead be output (e.g. by the client device or another client device) at block 540 or content responsive to the additional NL based input received at block 522 may instead be output (e.g. by the client device or another client device) at block 540.

Turning now to FIG. 6A, a non-limiting example of determining whether an NL based input is grammatically incorrect is depicted. An example client device 605 (e.g., an instance of the client device 110 from FIG. 1) taking the form of a smart speaker is shown. The client device 605 has one or more microphones to detect sounds and one or more speakers to output audio. The client device 605 also has a light source in the form of an LED 606.

An NL based input is associated with the client device 605. For instance, a user 601 of the client device 605 can provide the NL based input using the client device 605 (e.g., via spoken input captured in audio data generated by one or microphones of the client device 605). A user may provide the grammatically incorrect NL based input 610A of “What is the best outdoor activities in New York?”.

The NL based input 610A is received by a NL based response system (e.g. the NL based response system 120 described in relation to FIG. 1). The NL based response system 120 may be located remotely from the client device 605, with the client device 605 and the NL based response system 120 communicatively coupled with each other via one or more networks 199 as described previously, such as one or more wired or wireless local area networks (“LANs”, including Wi-Fi, mesh networks, Bluetooth, near-field communication, etc.) or wide area networks (“WANs”, including the Internet). However, in other examples, one or more components of the NL based response system 120 may be located within the client device 605.

Responsive to receiving the NL based input 610A associated with the client device 605, the NL based response system has generated, based on at least the NL based input 610A, a structured LLM query using any suitable method disclosed herein (e.g., as described in relation to FIG. 1, FIG. 2, FIG. 3, FIG. 4A or FIG. 5A). The NL based response system has also generated (using any suitable method disclosed herein, e.g. as described in relation to FIG. 1, FIG. 2, FIG. 3, FIG. 4A or FIG. 5A), based on processing the structured LLM query using an LLM, an LLM response, wherein the LLM response includes an indication of whether the NL based input contains a grammatical error. In the example of FIG. 6A, the NL based input 610A is grammatically incorrect since the word “is” should instead be “are” (i.e. a grammatically correct version of the NL based input 610A would be “What are the best outdoor activities in Ney York?”). The LLM response therefore contains an indication that the NL based input 610A contains a grammatical error.

Responsive to determining (using any suitable method disclosed herein (e.g., as described in relation to FIG. 1, FIG. 2, FIG. 3, FIG. 4A or FIG. 5A) that the NL based input 610A contains a grammatical error, the NL based response system causes a feedback output to be rendered at the client device 605. In this example, the feedback output is a visual output rendered using the LED 606 of the client device 605. Rendering the visual output may comprise illuminating the LED 606 of the client device 605, such as causing the LED 606 to flash. The rendering of the feedback output (i.e. the illumination of the LED 606) indicates to the user 601 that the NL based input 610A contained a grammatical error. As a result, the user may be encouraged to provide an additional NL based input 620A in an attempt to correct the grammatical error identified in the original NL based input 610A.

The user 601 provides, via the client device 605, the additional NL based input 620A of “What are the best outdoor activities in New York?”. The NL based response system determines whether the additional NL based input 620A is grammatically incorrect, using any suitable method disclosed herein (e.g., as described in relation to FIG. 1, FIG. 2, FIG. 3, FIG. 4A or FIG. 5A).

Responsive to determining in this instance that the additional NL based input 620A is not grammatically incorrect (i.e. it is grammatically correct), the NL based response system causes content 630A responsive to the additional NL based input to be output by the client device 605. For example, the client device 605 is caused to audibly render NL content 630A of “Some of the best outdoor activities in New York include cycling in Central Park and walking along the High Line” using one or more speakers of the client device 605. The content 630A may have been generated by processing the additional NL based input 620A using an LLM (e.g., an LLM stored in LLM(s) database 175), an ML model (e.g., an ML model stored in ML model(s) database 180), and or a search engine 182, for example. In some examples, the NL content may form part of an additional LLM response generated using the LLM when determining whether the additional NL based input was grammatically incorrect.

Although the initial feedback output has been described as a visual output rendered using a light source such as an LED 606 of the client device 605, it should be understood that in other examples the feedback output may additionally or alternatively comprise an audible output, for example rendered using one or more speakers of the client device 605.

Furthermore, while it has been described that the same client device 605 is used to receive the first NL based input 610A and additional NL based input 620A, it should be understood that in other examples the additional NL based input 620A may be received via a different client device to the client device 605 used to receive the first NL based input 610A. Furthermore, it is to be understood that the content 630A may in some examples be caused to be rendered using a different client device to the client device 605 that is used to render the feedback output. Furthermore, in some examples, the feedback output and/or the content 630A may be rendered using a different client device to the client device 605 used to receive the NL based input. For example, while the NL based input 610A is received via a client device 605 in the form of a smart speaker, the feedback output could be rendered using a wearable device of the user 601 such as a smart watch. In such an example, the feedback output could comprise a haptic output rendered by a vibration generator of the smart watch. Such a haptic feedback output could provide a discrete, unintrusive means of alerting the user 601 to the grammatical error. In other examples, the feedback output may be rendered using more than one client device, for example the feedback output may comprise an audible output rendered using two or more client devices.

Turning to FIG. 6B, another non-limiting example of determining whether an NL based input is grammatically incorrect is depicted. An example client device 605 (e.g., an instance of the client device 110 from FIG. 1) is shown. In a similar manner to the client device 605 of FIG. 6A, the client device 605 of FIG. 6B takes the form of a smart speaker. The client device 605 has one or more microphones to detect sounds and one or more speakers to output audio. The client device 605 also has a light source in the form of an LED 606.

A user 601 provides an initial NL based input 640A of “Assistant, make a note of the following”. The client device 605, or a system such as an NL based response system in communication with the client device 605, identifies the initial NL based input 640A as comprising a request for an assistant to transcribe. The system may cause an audible response 650A to be rendered at the client device 605, the audible response 650A acknowledging the initial NL based input 640A requesting the transcription. As an example shown in FIG. 6B, the audible response 650A is an NL audible response of “OK” rendered using a speaker of the client device 605.

The user 601 may subsequently provide an NL based input 660A of “Sarah drives to Denver last Tuesday to buy groceries” via the client device 605. An NL based response system (e.g. the NL based response system 120 described in relation to FIG. 1) in communication with the client device 605 determines, based at least on the initial NL based input 640A of “Assistant, make a note of the following”, that a structured LLM query is to be generated. That is, the NL based response system has determined from the initial NL based input 640A that the user has requested the client device 605 (or an assistant associated with the client device 605) perform dictation, and therefore the user 601 has implicitly requested incorrect grammar detection to be performed on the user's subsequent NL based inputs. Responsive to determining to generate a structured LLM query, the NL based response system generates a structured LLM query based on the NL based input 660A of “Sarah drives to Denver last Tuesday to buy groceries” and causes the generated LLM query to be processed by an LLM to generate an LLM response, using any suitable methods disclosed herein (e.g., as described in relation to FIG. 1, FIG. 2, FIG. 3, FIG. 4A or FIG. 5A). In this example, the structured LLM query contains an LLM prompt to cause the LLM to output an LLM response that includes both an indication of whether the NL based input 660A is grammatically incorrect and a grammatically correct version of the NL based input 660A.

Based on processing the indication in the LLM response, the NL based response system has determined that the NL based input 660A is grammatically incorrect and that a feedback output should be caused to be rendered. In this example, the NL based response system determines to cause an audible feedback output to be rendered by one or more speakers of the client device 605, wherein the feedback output comprises an audible output 670A of the word “Drove”. The audible output 670A is an audible rendering of at least a portion of the grammatically correct NL based input generated as part of the LLM response. The audible output 670A therefore alerts the user 601 to the presence of a grammatical error in the NL based input 660A while, in this example, also providing the user 601 with an indication of the specific grammatical error and how it may be corrected (i.e., replace the word “drives” in the NL based input with “drove”).

Responsive to the rendering of the feedback output 670A, the user 601 may provide an additional NL based input 680A via the client device 605 of “Sarah drive to Denver last Tuesday to buy groceries” via the client device 605. In this example, the user 601 has attempted to correct the grammatical error present in the previous NL based input 660A by replacing “drives” with “drive”, however the additional NL based input 680A is again grammatically incorrect. For example, the user may have misheard or misunderstood the feedback output 670A of “Drove” provided by the client device 605. Responsive to receiving the additional NL based input 680A, the NL based response system may determine that the additional NL based input 680A is also grammatically incorrect in accordance with any suitable method described herein (e.g., as described in relation to FIG. 1, FIG. 2, FIG. 3, FIG. 4A, FIG. 4B or FIG. 5A). Responsive to determining that the additional NL based input 680A is grammatically incorrect, the NL based response system may cause an additional feedback output 690A of “Do you mean “Sarah drove to Denver last Tuesday to buy groceries”?” to be audibly rendered using one or more speakers of the client device 605. The additional feedback output 690A differs from the previous feedback output 670A in that rather than audibly rendering a single word, an entire sentence has been audibly rendered, the sentence containing a grammatically correct version of the additional NL based input to guide the user 601 into providing a grammatically correct NL based input.

Responsive to the additional feedback output 690A being rendered, the user 601 provides a further NL based input 695A via the client device 605 of “Sarah drove to Denver last Tuesday to buy groceries”. The NL based response system may determine that the further NL based input 695A is now grammatically correct, using any suitable method described herein, for example in relation to e.g., as described in relation to FIG. 1, FIG. 2, FIG. 3, FIG. 4A, FIG. 4B, FIG. 5A or FIG. 5B). Responsive to determining that the additional NL based input 695A is grammatically correct, the NL based response system may take a further action, for example forwarding the further NL based response 695A to an LLM, ML model and/or search engine for further processing to generate content responsive to the further NL based input, or storing the further NL based input in transient or non-transient memory as part of a dictation process.

Turning to FIG. 7, another non-limiting example of determining whether an NL based input is grammatically incorrect is depicted. In this example, the client device 710 takes the form of a handheld mobile device such as a mobile phone, the client device 710 having a display 720 rendering a graphical interface.

The graphical interface includes a graphical rendering of an NL based input 730A associated with the client device 710 (e.g., which may be an instance of the client device 110 from FIG. 1). A user of the client device 710 can provide the NL based input 730A (e.g., via spoken input captured in audio data generated by one or microphones of the client device 710, via touch or typed input received at a touch screen display of the client device 710, etc.).

In the example shown in FIG. 7, the NL based input 730A comprises instructions for controlling a robot (e.g. the robot 190 of FIG. 1), the NL based input 730A stating “Tell the robot to move near the table and picked up the apple”. The NL based input 730A is grammatically incorrect and should instead read “Tell the robot to move near the table and pick up the apple”.

Responsive to receiving the NL based input 730A, an NL based response system (e.g. the NL based response system 120 of FIG. 1) generates a structured LLM query and LLM response using any suitable method disclosed herein.

Responsive to determining that the NL based input 730A is grammatically incorrect, the NL based response system has caused the client device 710 to render a feedback output indicating to a user of the client device 710 that the NL based input 730A is grammatically incorrect. FIG. 7 shows the feedback output comprising two visual outputs. Firstly, the client device 710 has caused the natural language based input 730A to be rendered in the graphical interface with a grammatically incorrect portion 733 being highlighted. Secondly, the client device 710 has rendered on the graphical interface an NL statement 732A that verbally notifies a user that the NL based input 730A is grammatically incorrect. In this example, the NL statement 732A recites “Grammar error detected. Please restate your command.”, prompting the user to provide a follow-up NL based input that corrects the grammar error(s).

The user has subsequently provided an additional NL based input 734A (e.g., via spoken input captured in audio data generated by one or microphones of the client device 710, via touch or typed input received at a touch screen display of the client device 710, etc.) of “Tell the robot to move near the table and picked up the apple.”, which has been rendered in the graphical interface. Once again, this additional NL based input 734A is grammatically incorrect.

Responsive to determining that the additional NL based input 734A is grammatically incorrect, using any suitable method disclosed herein, the NL based response system has caused the client device 710 to render an additional feedback output indicating to a user of the client device 710 that the additional NL based input 734A is grammatically incorrect. In this example, the additional feedback output is different to the previous feedback output. FIG. 7 shows the additional feedback output as a visual output comprising a rendering of the additional NL statement 736A “Try: “Tell the robot to move near the table and pick up the apple.”” on the graphical interface. The additional feedback output therefore provides the user with a more explicit verbal indication of the grammatical error compared to the feedback output(s) provided earlier.

The user has subsequently provided a further NL based input 738A (e.g., via spoken input captured in audio data generated by one or microphones of the client device 710, via touch or typed input received at a touch screen display of the client device 710, etc.) of “Tell the robot to move near the table and pick up the apple.”, which has been rendered in the graphical interface. This further NL based input 738A is grammatically correct.

Responsive to determining that the further NL based input 738A is grammatically correct, using any suitable method disclosed herein, the NL based response system causes content responsive to the further NL based input 738A (or the NL based input 730A or the additional NL based input 734A) to be output. For example, the NL based response system may transmit to the robot 190 content comprising instructions for controlling the robot 190 (e.g., one or more actuators of the robot 190). The content comprising the instructions may be contained in an LLM response that was generated when determining whether the further NL based input 738A is grammatically incorrect, or may have been generated responsive to determining that the further NL based input 738A is not grammatically incorrect. The NL based response system has also caused the graphical interface of the client device 710 to include a statement 740A indicating to the user that an action is being taken, in this example the statement 740A stating “OK. Robot is picking up the apple.”.

Turning now to 8, another non-limiting example of determining whether an NL based input is grammatically incorrect is depicted. Referring specifically to FIG. 8, the client device 810 is depicted as taking the form of an in-vehicle computing device contained in a vehicle 800 such as a car. A NL based response system (e.g., the NL based response system 120 of FIG. 1) may form part of the client device 810, or may be separate from the client device 810 but be in communication with the client device 810 via one or more networks (e.g., one or more networks 199 of FIG. 1). In examples where the NL based response system is separate from the client device 810, the NL based response system may be located within the vehicle 800, or it may be external from the vehicle (i.e. located remotely from the vehicle). The NL based response system may be in communication with a vehicular control system for controlling one or more operations of the vehicle 800, such as vehicle navigation.

The client device 810 includes a display 820 rendering a graphical interface. The display 820 of the computing device 810 enables the user to interact with content rendered on the display 820 by typed or touch input (e.g., by directing user input to the display 820 or textual interface element 812) and/or by spoken input (e.g., by selecting microphone interface element 814—or just by speaking without necessarily selecting the microphone interface element 814.

The user of the vehicle 800 invoked provides a spoken utterance that generates an NL based input 840A of “Took the next left”. In this example, audio data capturing the spoken utterance can be processed to determine that the spoken utterance includes the NL based input 840A. The NL based input 840A comprises a request for the vehicular control system of the vehicle 800 to take an action (e.g., to generate instructions to cause the vehicle 800 to turn left).

Using various techniques described herein (e.g., with respect to FIG. 2), the system can determine that the NL based input 840A is grammatically incorrect.

Accordingly, the system can cause a feedback output to be rendered. In the example of FIG. 8, the feedback output comprises an audible output rendered by a speaker of the client device as an audible ‘beep’ 842A. In some examples, responsive to determining that the NL based input 840A is grammatically incorrect, the NL based response system 120 may cause the feedback output to be rendered in lieu of taking another action. For example, the feedback output may be caused to be rendered in lieu of causing the NL based input 840A to be processed using an LLM (e.g., of the LLM(s) database 175) and/or one or more other ML models (e.g., of ML model(s) database 180) to generate content responsive to the NL based input 840A, such as instructions for transmitting the vehicular control system to control navigation of the vehicle 800.

After hearing the audible feedback output rendered using the client device 810, the user may attempt to correct the grammatical error in the NL based input 840A by providing an additional NL based input 844A of “Takes the next left”. The system has determined whether the additional NL based input 844A is grammatically incorrect using any suitable method disclosed herein and, in response to a determination that the additional NL based input 844A is grammatically incorrect, the system has caused a visual feedback output 846A of “Do you mean “Take the next left”?” to be rendered on the graphical interface of the display 820. The feedback output 846A has indicated to the user that the additional NL based input 844A was grammatically incorrect, and has provided the user with a grammatically correct version of the additional NL based input 844A in the form of a question.

Responsive to the rendering of the feedback output 846A, the user has provided a further NL based input 848A of “Yes” in response the question posed in the feedback output 846A, to indicate to the system that the user agrees with the grammatically correct version of the additional NL based input 844A. Responsive to receiving this affirmative further NL based input 848A, the system has generated content responsive to the grammatically correct version of the additional NL based input 844A (e.g., instructions for controlling the vehicle 800) and has transmitted the content to the vehicle control system. The system has also caused a feedback output 850A of “OK. Vehicle taking the next left” to be rendered at the graphical interface of the display 820, to inform the user of the content being transmitted to the vehicle control system.

Turning now to FIG. 9, a block diagram of an example computing device 910 that may optionally be utilized to perform one or more aspects of techniques described herein is depicted. In some implementations, one or more of a client device, cloud-based automated assistant component(s) or other cloud-based software application component(s), and/or other component(s) can include one or more components of the example computing device 910.

Computing device 910 typically includes at least one processor 914 which communicates with a number of peripheral devices via bus subsystem 912. These peripheral devices can include a storage subsystem 924, including, for example, a memory subsystem 925 and a file storage subsystem 926, user interface output devices 920, user interface input devices 922, and a network interface subsystem 916. The input and output devices allow user interaction with computing device 910. Network interface subsystem 916 provides an interface to outside networks and is coupled to corresponding interface devices in other computing devices.

User interface input devices 922 can include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 910 or onto a communication network.

User interface output devices 920 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide non-visual display such as via audio output devices. In general, use of the term “output device” is intended to include all possible types of devices and ways to output information from computing device 910 to the user or to another machine or computing device.

Storage subsystem 924 stores programming and data constructs that provide the functionality of some or all of the modules described herein. For example, the storage subsystem 924 can include the logic to perform selected aspects of the methods disclosed herein, as well as to implement various components depicted in FIG. 1.

These software modules are generally executed by processor 914 alone or in combination with other processors. Memory 925 used in the storage subsystem 924 can include a number of memories including a main random access memory (RAM) 930 for storage of instructions and data during program execution and a read only memory (ROM) 932 in which fixed instructions are stored. A file storage subsystem 926 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 926 in the storage subsystem 924, or in other machines accessible by the processor(s) 914.

Bus subsystem 912 provides a mechanism for letting the various components and subsystems of computing device 910 communicate with each other as intended. Although bus subsystem 912 is shown schematically as a single bus, alternative implementations of the bus subsystem 912 can use multiple busses.

Computing device 910 can be of varying types including a workstation, server, computing cluster, blade server, server farm, or any other data processing system or computing device. Due to the ever-changing nature of computers and networks, the description of computing device 910 depicted in FIG. 9 is intended only as a specific example for purposes of illustrating some implementations. Many other configurations of computing device 910 are possible having more or fewer components than the computing device depicted in FIG. 9.

In situations in which the systems described herein collect or otherwise monitor personal information about users, or can make use of personal and/or monitored information), the users can be provided with an opportunity to control whether programs or features collect user information (e.g., information about a user's social network, social actions or activities, profession, a user's preferences, or a user's current geographic location), or to control whether and/or how to receive content from the content server that can be more relevant to the user. Also, certain data can be treated in one or more ways before it is stored or used, so that personal identifiable information is removed. For example, a user's identity can be treated so that no personal identifiable information can be determined for the user, or a user's geographic location can be generalized where geographic location information is obtained (such as to a city, ZIP code, or state level), so that a particular geographic location of a user cannot be determined. Thus, the user can have control over how information is collected about the user and/or used.

What is claimed is:

1. A method implemented by one or more processors, the method comprising:
receiving natural language (NL) based input associated with a client device;
generating, based on the NL based input, a structured large language model (LLM) query, wherein the structured LLM query comprises an LLM prompt to cause an LLM to generate an LLM response that includes an indication of whether the NL based input is grammatically incorrect;
generating the LLM response based on causing the structured LLM query to be processed using the LLM, the LLM response including the indication of whether the NL based input is grammatically incorrect;
determining, based on processing the indication included in the LLM response, whether the NL based input is grammatically incorrect; and
responsive to determining that the NL based input is grammatically incorrect, causing a feedback output to be rendered at the client device or an additional client device, the feedback output to indicate to a user that the NL based input is grammatically incorrect.

2. The method of claim 1, wherein the LLM prompt is a predetermined prompt that has been stored prior to receiving the NL based input.

3. The method of claim 1, further comprising:
determining whether to generate the structured LLM query, and
wherein generating the structured LLM query is performed in response to determining to generate the structured LLM query.

4. The method of claim 3, wherein determining whether to generate the structured LLM query is based on receiving an indication of a user input to initiate incorrect grammar detection.

5. The method of claim 1, wherein:
the LLM prompt further causes the LLM to output, in the LLM response, a grammatically correct version of the NL based input; and
wherein the method further comprises causing at least a portion of the grammatically correct version of the NL based input to be rendered by the client device or the additional client device.

6. The method of claim 5, further comprising:
subsequent to causing the feedback output to be rendered, receiving an additional NL based input;
determining whether the additional NL based input is grammatically incorrect; and
responsive to determining that the additional NL based input is grammatically incorrect, causing an additional feedback output to be rendered at the client device or the additional client device, the additional feedback output to indicate to the user that the additional NL based input is grammatically incorrect.

7. The method of claim 6, wherein the feedback output comprises a visual output and the additional feedback output comprises an audible output.

8. The method of claim 6, wherein:
the LLM prompt causes the LLM to output, in the LLM response, a grammatically correct version of the NL based input; and
wherein the additional feedback output comprises at least a portion of the grammatically correct version of the NL based input.

9. The method of claim 6, wherein determining whether the additional NL based input is grammatically incorrect comprises:
generating, based on the additional NL based input, an additional structured LLM query;
generating an additional LLM response based on causing the additional structured LLM query to be processed using the LLM or a different LLM, wherein the additional LLM response includes an indication of whether the additional NL based input is grammatically incorrect; and
determining, based on processing the additional LLM response, whether the additional NL based input is grammatically incorrect.

10. The method of claim 6, wherein:
determining whether the additional NL based input is grammatically incorrect comprises performing a comparison between at least a portion of the additional NL based input and at least a portion of the grammatically correct version of the NL based input; and
wherein the additional NL based input is determined to be grammatically incorrect based on a result of the comparison.

11. The method of claim 1, wherein causing the feedback output to be rendered comprises:
causing at least a portion of the NL based input to be rendered as an audible or visible NL based output; and
causing an audible or visible indication of at least one grammatical error in the NL based output to be rendered.

12. The method of claim 1, further comprising:
subsequent to causing the feedback output to be rendered, receiving an additional NL based input;
generating, based on the additional NL based input, an additional structured LLM query;
generating, based on causing the additional structured LLM query to be processed using the LLM or a different LLM, an additional LLM response, wherein the additional LLM response includes an indication of whether the additional NL based input is grammatically incorrect; and
causing an additional feedback output to be rendered at the client device or the additional client device, the additional feedback output to indicate to the user that the additional NL based input is grammatically incorrect.

13. The method of claim 12, wherein the feedback output indicates a grammatical error in the NL based input with a first level of granularity,
wherein the additional feedback output indicates a grammatical error in the further NL based input with a second level of granularity, and
wherein the second level of granularity is greater than the first level of granularity.

14. The method of claim 1, wherein:
the NL based input comprises a query for information;
the LLM response comprises content responsive to the query for information; and
the feedback output is caused to be rendered in lieu of rendering the content responsive to the query for information.

15. The method of claim 1, wherein the indication in the LLM response is indicative of at least one of:
a relative importance of a grammatical error identified in the NL based input;
a location of a grammatical error identified in the NL based input; or
a type of grammatical error identified in the NL based input.

16. The method of claim 1, wherein the indication in the LLM response comprises an error value, the error value being indicative of a relative importance of at least one grammatical error contained in the NL based input, wherein causing the feedback output to be rendered is based on a magnitude of the error value.

17. The method of claim 1, wherein causing the feedback output to be rendered at the client device or the additional client device comprises transmitting data to the client device or the additional device that is operable for causing the client device or the additional device to render the feedback output.

18. A method implemented by one or more processors, the method comprising:
receiving natural language (NL) based input associated with a client device;
determining whether to generate a structured large language model (LLM) query, the structured LLM query comprising a prompt to cause an LLM to generate an LLM response that includes an indication of whether the NL based input is grammatically incorrect;
in response to determining to generate the structured LLM query:
generating the structured large language model (LLM) query based on the NL based input, wherein the structured LLM query comprises a prompt to cause the LLM to generate the LLM response that includes the indication of whether the NL based input is grammatically incorrect; and
generating the LLM response based on processing the structured LLM query using the LLM, wherein the LLM response includes the indication of whether the NL based input is grammatically incorrect;
determining, based on processing the LLM response, whether the NL based input is grammatically incorrect; and
responsive to determining that the NL based input is grammatically incorrect, causing a feedback output to be rendered at the client device or an additional client device, the feedback output to indicate to a user that the NL based input is grammatically incorrect.

19. The method of claim 18, wherein determining whether to generate a structured large language model (LLM) query is based on receiving an indication of a user input to initiate incorrect grammar detection.

20. The method of claim 18, further comprising:
subsequent to causing the feedback output to be rendered, receiving an additional NL based input;
determining whether to generate an additional structured LLM query for the additional NL based input, the additional structured LLM query comprising a prompt to cause an LLM to generate an LLM response that includes an indication of whether the additional NL based input is grammatically incorrect; and
in response to determining not to generate the additional structured LLM query:
causing the additional NL based input to be processed by at least one machine learning (ML) model to generate ML output responsive to the additional LLM query, in lieu of generating the additional structured LLM query.
